(19) United States
(12) Patent Application Publication
(10) Pub. No.: US 2004/0181909 A1
(43) Pub. Date: Sep. 23, 2004

(54) Hinge unit and hinge structure using the same

(75) Inventor: Masanobu Kawamoto, Yokohama-shi (JP)

Correspondence Address: HAUPTMAN KANESAKA BERNER PATENT AGENTS, LLP, Suite 310, 1700 Diagonal Road, Alexandria, VA, 22314, US

(73) Assignee: NIFCO INC.

(21) Appl. No.: 10/757,991

(22) Filed: Jan. 16, 2004

(30) Foreign Application Priority Data
Mar. 5, 2003 (JP) 2003-058244

(51) Int. Cl. E05D 11/10

(52) U.S. Cl. 16/330

(57) ABSTRACT

Engaging grooves are provided in a stopper in addition to engaging grooves engaging with a key portion of an actuator, so that a receiver portion can be stopped on the way that the receiver portion is fully opened. Also, a twisting coil spring applies a twisting force to a sub-cam and the actuator, and urges a button in a direction where an engagement state between the key portions and the engaging grooves is released. As a result, when the button portion is pressed for a long time, the receiver portion is fully opened at once. Therefore, it is convenient that the receiver portion can be opened up to approximately 90° by pushing the button portion just once, and, at the same time, can be held at the position of approximately 90°.

### BACKGROUND OF THE INVENTION AND RELATED ART STATEMENT

The present invention relates to a hinge unit and a hinge structure with the hinge unit used for a folding type electronic device such as a mobile phone, etc.

As an example of a hinge structure used for a folding type electronic device, a fleece-top-type hinge attached to a mobile phone is known, in which a receiver portion of the phone opens and closes relative to a transmitter portion of the phone with a friction at the hinge.

As the mobile phone has been prevail, it has been required that a hinge structure is configured such that the receiver portion can fully open with one hand through one-touch operation (refer to Japanese Patent Application No. 2001-83636).

A mobile phone with a camera has also become popular, and the mobile phone has been used as a telephone as well as a camera. When such a mobile phone is used to take a picture in a self-timer mode, it is often necessary to place the mobile phone on a table with a receiver portion thereof opening at approximately 90°. In this case, it is necessary to press a button to return the receiver portion from a full-open state to an open angle of approximately 90°, thereby causing inconveniences.

In view of the problem described above, the present invention has been made, and an object of the invention is to provide a hinge unit and a hinge structure using the hinge unit in which the receiver portion can be opened fully or at a predetermined angle with one push operation.

### SUMMARY OF THE INVENTION

In order to achieve the objects described above, according to a first embodiment of the present invention, a hinge unit includes a rotational axis housed in a case rotatably and slidably in an axial direction of the case, and having a key portion on an outer periphery surface thereof; a stopper fixed to the case for inserting the rotational axis and having a plurality of engaging portions for engaging the key portion; a sub-cam inserted into an end of the rotational axis to be slidable and rotatable together with the rotational axis; first urging means connected to the sub-cam and the stopper for imparting a twisting force to the sub-cam and for urging the sub-cam in a direction away from the stopper; a cap fixed to the case for inserting the rotational axis and controlling a sliding movement of the sub-cam urged by the first urging means; fastener means fixed to the end of the rotational axis to be slidable relative to the case; second urging means provided between the cap and the fastener means for urging the fastener means in a direction away from the cap and pulling the rotational axis through the fastener means so that the engaging portions engage the key portion; and a button portion fixed to the fastener means for pushing the rotational axis against the second urging means to slide so that the engaging portions are released from the key portion.

In the first embodiment, the rotational axis is provided with the key portion on the outer periphery surface thereof, and is housed in the case rotatably and slidably in the axial direction of the case. The stopper is fixed to the case for inserting the rotational axis and has the plurality of the engaging portions for engaging the key portion.

The sub-cam is inserted in the end of the rotational axis to be rotatable together with the rotational axis and slidable relative to the rotational axis. The first urging means is connected to the sub-cam and the stopper for twisting the sub-cam so that the rotational axis rotates through the sub-cam, and for urging the sub-cam in the direction away from the stopper.

The cap is fixed to the case for inserting the rotational axis and controlling the sliding movement of the sub-cam urged with the first urging means. The fastener means is fixed to the end of the rotational axis to be slidable relative to the case.

Further, the second urging means is provided between the cap and the fastener means for urging the fastener means in the direction away from the cap and pulling the rotational axis through the fastener means so that the engaging portions engage the key portion. The button portion is fixed to the fastener means for pushing the rotational axis against the second urging means to slide so that the engaging portions are released from the key portion.

Here, the plurality of the engaging portions is provided in the stopper for engaging the key portion. Accordingly, when the key port in reaches a position corresponding to the engaging portions before the rotational axis reaches a maximum angle through the twisting force by the first urging means, the second urging means pulls back the rotational axis.

As a result, the key portion engages the engaging portions to stop the rotational axis. The button portion pushes the rotational axis in the direction that the engaging portions are released from the key portion. Therefore, it is possible to selectively engage the key portion with one of the engaging portions and release the key portion according to a pressing time of the button portion.

More specifically, in a case that the hinge structure is applied to an axial portion of a mobile phone, a receiver portion is connected to the rotational axis. Accordingly, it is possible to stop the receiver portion at an angle, for example at approximately 90°, other than a fully opened state through a one-push operation.

The first urging means applies the twisting force to the sub-cam and the rotational axis, and the button portion pushes the rotational axis in the direction that the key portion is released from the engaging portions. Accordingly, when the button portion is pressed for a long time, the receiver portion is opened up to the fully opened state through the twisting force of the first urging means.

Therefore, when the hinge structure is applied to a mobile phone with a camera, it is possible to conveniently select an appropriate opening angle of the receiver portion according to the pressing time of the button portion depending on whether the mobile phone is used as the camera or as the phone.

Further, the second urging means urges the button portion in the direction away from the cap and pulls the rotational axis through the fastener means in an ordinal state. A force of pulling back the rotational axis is proportion to a force of the engagement between the key portion and the engaging portions. Accordingly, when it is necessary to strongly engage the key portion with the engaging portions, it is preferred to increase the force of pulling the rotational axis. In this case, however, it is necessary to press the button portion with a large force, thereby making it difficult to operate.

In addition, the first urging means applies the twisting force, so that a frictional force is generated between the key portion and the engaging portions, and the frictional force becomes resistance when the rotational axis is pulled back.

Therefore, in addition to the first urging means, the second urging means is provided for pulling the rotational axis, thereby reducing the force required for pulling the rotational axis and the resisting force against the pressing force of the button portion.

According to a second embodiment of the present invention, the hinge unit includes a plurality of depressions or projections formed on a surface of the cap facing the sub-cam; and projections or depressions formed on a surface of the sub-cam facing the cap for engaging the depressions or the projections of the cap through rotation.

In the second embodiment of the present invention, the hinge unit includes the plurality of the depressions or projections formed on the surface of the cap facing the sub-cam; and the projections or depressions formed on the surface of the sub-cam facing the cap to become engaging or disengaging condition with the depressions or the projections of the cap through rotation.

Since the sub-cam is urged toward the cap side by the first urging means, the depressions or the projections of the cap can steadily engage the projections or the depressions of the sub-cam. In a state that the key portion engages the engaging portions, the depressions or the projections of the cap securely engage the projections or the depressions of the sub-cam to restrict the rotation of the rotational axis even through the sub-cam.

According to a third embodiment of the present invention, sidewalls of the depressions of the cap are formed of an inclined portion and a substantially standing wall. The projections of the sub-cam are pressed against the standing walls with the twisting force of the first urging means, and corners of the projections abut against the inclined portions.

In the third embodiment of the present invention, the sidewalls of the depressions of the cap are formed of the inclined portion and the substantially standing wall. The projections of the sub-cam are pressed against the standing walls with the twisting force of the first urging means, and the corners of the projections abut against the inclined portions.

For example, when the hinge structure is applied to the axial portion of the mobile phone, the key portion engages the engaging portions at the fully opened position or at approximately 90° of the receiver portion. At the same time, the projections of the sub-cam are pressed against the standing walls of the depressions of the cap. Accordingly, the twisting force of the first urging means is locked, and no frictional force by the twisting force is applied between the rotational axis and the sub-cam when the rotational axis slides.

As a result, it is possible to use the urging force of the second urging means (force of pulling back the rotational axis) to the maximum extent. Therefore, the receiver portion can be reliably held at the fully opened position or at approximately 90° of the receiver portion.

Further, since the corners of the projections of the sub-cam abut against the inclined surfaces of the depressions of the cap, in order to apply the rotational force to the rotational axis, it is necessary to apply a force so that the projections of the sub-cam climb over the inclined surfaces, in addition to the resisting force by the twisting force of the first urging means. As a result, it is possible to increase the force of holding the receiver portion, thereby preventing rattle of the receiver portion when the mobile phone is shaken.

According to a fourth embodiment of the present invention, sidewalls of the depressions of the sub-cam are formed of an inclined portion and a substantially standing wall. The projections of the cap are pressed against the standing walls with the twisting force of the first urging means, and corners of the projections abut against the inclined portions.

In the fourth embodiment of the present invention, sidewalls of the depressions of the sub-cam are formed of the inclined portion and the substantially standing wall. The projections of the cap are pressed against the standing walls with the twisting force of the first urging means, and the corners of the projections abut against the inclined portions.

Since the projections of the cap abut against the substantially standing walls with the twisting force of the first urging means to lock the twisting force of the first urging means, when the rotational axis slides, no frictional force by the twisting force is applied between the rotational axis and the sub-cam.

According to a fifth embodiment of the present invention, the hinge unit includes a drive cap fitted into one end of the rotational axis; a cam portion formed on an outer periphery surface of the rotational axis; and a cam groove formed in an inner periphery surface of the drive cap for engaging the cam portion to convert a sliding force of the rotational axis into a rotational force of the drive cap.

In the fifth embodiment of the present invention, since the cam groove is formed for converting the sliding force of the rotational axis into the rotational force of the drive cap, when the rotational axis slides for a predetermined distance, the drive cap can reliably rotate by a predetermined angle.

According to a sixth embodiment of the present invention, the engaging portions are disposed at positions corresponding to positions of the key portion, and the depressions are disposed at positions corresponding to positions of the projections when the rotational axis rotates for 80° to 140° or approximately 165°.

Accordingly, it is possible to stop the rotational axis at an angle between 80° and 140° or approximately 165°. When the hinge unit is applied to, for example, the mobile phone with a camera, it is possible to hold the receiver portion at an angle between 80° and 140° or approximately 165°.

When the mobile phone includes a timer function with a self-timer, the mobile phone needs to be placed on a table in a state that the receiver portion opens at approximately 90°, and it is possible to conveniently hold the receiver portion at approximately 90°.

Here, the opening angle of the receiver portion is preferably set at 93° to 97°, so that the table does not block a view and a wide shooting range can be obtained.

According to a seventh embodiment of the present invention, a hinge structure includes the hinge unit of any one of the first to sixth embodiments. The case described in any one of the first to sixth embodiments is fixed to an axial portion of a first housing member. The rotational axis or the drive cap described in any one of the first to sixth embodiments is fixed to an axial portion of a second housing member, so that the first housing member rotates relative to the second housing member.

In the seventh embodiment of the present invention, the case is fixed to the axial portion of the first housing member, and the rotational axis or the drive cap is fixed to the axial portion of the second housing member, so that the first housing member rotates relative to the second housing member.

According to an eighth embodiment of the present invention, a damper is provided in the axial portion of one of the first housing member and the second housing member for damping the urging force of the first urging means according to the opening angle of the first housing member or the second housing member after the key portion is released from the engaging portions.

In the eighth embodiment of the present invention, the urging force of the first urging means is changed according to the opening angle of the first housing member or the second housing member after the key portion is released from the engaging portions.

When the engagement state between the key portion and the engaging portions is released, the first urging means urges the first housing member or the second housing member in the opening direction. The first housing member or the second housing member opens with large fluctuations in opening torque depending on the opening angle of the first housing member or the second housing member. At a side that the first housing member or the second housing member starts to open, the opening torque for opening the first housing member or the second housing member is large. At a side of completing the opening (fully opened), the torque is small.

Therefore, by changing the braking force according to the opening angle of the first housing member or the second housing member, at the side that the first housing member or the second housing member is started to open, the breaking force is small, and at the side of completing the opening (fully opened), the breaking force is large. The first housing member or the second housing member can open fast up to a predetermined angle. After the predetermined angle, the opening speed of the first housing member or the second housing member is reduced, and the first housing member or the second housing member can be opened slowly.

According to a ninth embodiment of the present invention, the damper includes a wing portion provided in a rotor; a housing with a substantially cylindrical shape filled with viscous fluid for pivotally supporting the rotor and having various distances between an inner periphery surface and an end of the wing portion changing according to a rotational angle of the rotor; and a dividing wall projecting from the inner periphery surface of the housing for forming liquid chambers communicating with each other.

In the ninth embodiment of the present invention, the housing is filled with the viscous fluid, and the wing portion is rotatable along with the rotor. The distance between the inner periphery surface and the end of the wing portion is changed according to the rotational angle of the rotor for changing a compressive resistance generated between the inner periphery surface and the end of the wing portion.

The dividing wall projects from the inner periphery surface of the housing for forming the liquid chambers communicating each other. When the wing portion moves, a volume of the liquid chamber is reduced to increase a compression ratio of the viscous fluid, thereby increasing viscous resistance on the wing portion with the rotation of the wing portion.

Further, while the rotational angle of the rotor increases, the distance between the inner periphery surface of the housing and the end of the wing portion is reduced. Accordingly, it is possible to further increase the viscous resistance of the fluid passing through the gap between the inner periphery surface of the housing and the end of the wing portion, and the viscous resistance on the wing portion can be additionally increased. When the viscous fluid flows between the liquid chambers, the viscous fluid is compressed and the passing resistance of the fluid passing through the gap between the outer periphery surface of the rotor and the end of each dividing wall is added, thereby obtaining a high torque (high braking force).

Accordingly, it is possible to change the force applied on the wing portion according to the opening angle of the first housing member or the second housing member, thereby improving efficiency of generating the torque and obtaining the high torque (high braking force).

### BRIEF DESCRIPTION OF THE DRAWINGS

FIG. 1 is an exploded perspective view showing a base portion and a monitor portion of a mobile phone with a hinge unit according to an embodiment of the present invention;

FIG. 2 is an exploded perspective view showing the hinge unit and one of axial portions of the mobile phone according to the embodiment of the invention;

FIG. 3 is an exploded perspective view of the hinge unit according to the embodiment of the invention;

FIG. 4(A) is a side view of the mobile phone with the hinge unit according to the embodiment of the invention; FIG. 4(B) is a cross sectional view of the hinge unit shown in FIG. 4(A); FIG. 4(C) is a deployed view showing a relationship between key portions and engaging grooves of the hinge unit corresponding to FIG. 4(A); and FIG. 4(D) is a deployed view showing a relationship between engaging ribs and engaging depressions of the hinge unit corresponding to FIG. 4(A);

FIG. 5(A) is a side view of the mobile phone with the hinge unit according to the embodiment of the invention; FIG. 5(B) is a cross sectional view of the hinge unit corresponding to FIG. 5(A); FIG. 5(C) is a deployed view showing the relationship between the key portions and the engaging grooves of the hinge unit corresponding to FIG. 5(A); and FIG. 5(D) is a deployed view showing the relationship between the engaging ribs and the engaging depressions of the hinge unit corresponding to FIG. 5(A);

FIG. 6(A) is a side view of the mobile phone with the hinge unit with respect to the embodiment of the invention; FIG. 6(B) is a cross sectional view of the hinge unit corresponding to FIG. 6(A); FIG. 6(C) is a deployed view showing the relationship between the key portions and the engaging grooves of the hinge unit corresponding to FIG. 6(A); and FIG. 6(D) is a deployed view showing the relationship between the engaging ribs and the engaging depressions of the hinge unit corresponding to FIG. 6(A);

FIG. 7(A) is a side view of the mobile phone with the hinge unit with respect to the embodiment of the invention; FIG. 7(B) is a cross sectional view of the hinge unit corresponding to FIG. 7(A); FIG. 7(C) is a deployed view showing the relationship between the key portions and the engaging grooves of the hinge unit corresponding to FIG. 7(A); and FIG. 7(D) is a deployed view showing the relationship between the engaging ribs and the engaging depressions of the hinge unit corresponding to FIG. 7(A)

FIG. 8(A) is a side view of the mobile phone with the hinge unit with respect to the embodiment of the invention; FIG. 8(B) is a cross sectional view of the hinge unit corresponding to FIG. 8(A); FIG. 8(C) is a deployed view showing the relationship between the key portions and the engaging grooves of the hinge unit corresponding to FIG. 8(A); and FIG. 8(D) is a deployed view showing the relationship between the engaging ribs and the engaging depressions of the hinge unit corresponding to FIG. 8(A);

FIG. 9(A) is a deployed view showing the relationship between the key portions and the engaging grooves of the hinge unit according to the embodiment of the invention; and FIG. 9(B) is a deployed view showing the relationship between the engaging ribs and the engaging depressions;

FIG. 10 is an explanatory drawing showing a relationship between a cam surface of an actuator and a cam groove of a cam member provided in the hinge unit according to the embodiment of the invention;

FIGS. 11(A) and 11(B) are side views showing the relationship between the cam surface of the actuator and the cam groove of the cam member provided in the hinge unit according to the embodiment of the invention, wherein FIG. 11(A) shows a state before the actuator slides, and FIG. 11(B) shows a state after the actuator slides;

FIG. 12 is an exploded perspective view showing the other of the axial portions of the mobile phone with the hinge unit according to the embodiment of the invention;

FIG. 13 is an exploded perspective view of a damper of the mobile phone with the hinge unit according to the embodiment of the invention;

FIG. 14(A) is a side view of the mobile phone with the hinge unit according to the embodiment of the invention; FIG. 14(B) is a cross sectional view of the damper of the hinge unit corresponding to FIG. 14(A); and FIG. 14(C) is a cross sectional view showing a relationship between an inner periphery surface of a housing and wing portions of the hinge unit corresponding to FIG. 14(A);

FIG. 15(A) is a side view of the mobile phone with the hinge unit according to the embodiment of the invention; FIG. 15(B) is a cross sectional view of the damper of the hinge unit corresponding to FIG. 15(A); and FIG. 15(C) is a cross sectional view showing the relationship between the inner periphery surface of the housing and the wing portions of the hinge unit corresponding to FIG. 15(A);

FIG. 16(A) is a side view of the mobile phone with the hinge unit according to the embodiment of the invention; FIG. 16(B) is a cross sectional view of the damper of the hinge unit corresponding to FIG. 16(A); and FIG. 16(C) is a cross sectional view showing the relationship between the inner periphery surface of the housing and the wing portions of the hinge unit corresponding to FIG. 16(A);

FIG. 17(A) is a side view of the mobile phone with the hinge unit according to the embodiment of the invention; FIG. 17(B) is a cross sectional view of the damper of the hinge unit corresponding to FIG. 17(A); and FIG. 17(C) is a cross sectional view showing the relationship between the inner periphery surface of the housing and the wing portions of the hinge unit corresponding to FIG. 17(A);

FIG. 18(A) is a side view of the mobile phone with the hinge unit according to the embodiment of the invention; FIG. 18(B) is a cross sectional view of the damper of the hinge unit corresponding to FIG. 18(A); and FIG. 18(C) is a cross sectional view showing the relationship between the inner periphery surface of the housing and the wing portions of the hinge unit corresponding to FIG. 18(A);

FIG. 19(A) is a side view of the mobile phone with the hinge unit according to the embodiment of the invention; FIG. 19(B) is a cross sectional view of the damper of the hinge unit corresponding to FIG. 19(A); and FIG. 19(C) is a cross sectional view showing the relationship between the inner periphery surface of the housing and the wing portions of the hinge unit corresponding to FIG. 19(A);

FIG. 20(A) is a side view of the mobile phone with the hinge unit according to the embodiment of the invention; FIG. 20(B) is a cross sectional view of the damper of the hinge unit corresponding to FIG. 20(A); and FIG. 20(C) is a cross sectional view showing the relationship between the inner periphery surface of the housing and the wing portions of the hinge unit corresponding to FIG. 20(A); and

FIG. 21(A) is a side view of a mobile phone with a hinge unit according to an embodiment of the invention; FIG. 21(B) is a cross sectional view of a damper of the hinge unit corresponding to FIG. 21(A); and FIG. 21(C) is a cross sectional view showing a relationship between an inner periphery surface of a housing and wing portions of the hinge unit corresponding to FIG. 21(A).

### DETAILED DESCRIPTION OF PREFERRED EMBODIMENTS

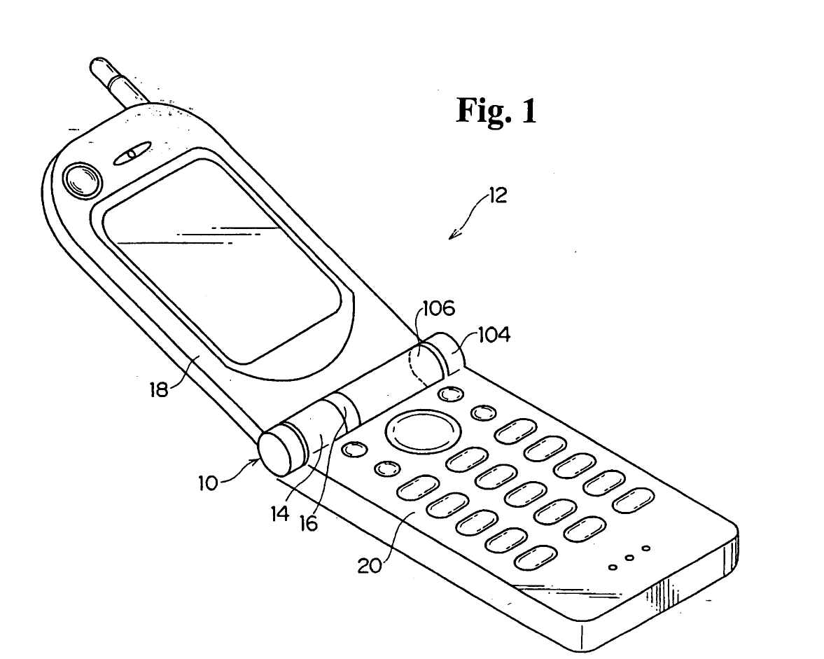

FIG. 1 shows a mobile phone 12 with a photograph function to which a hinge structure of a hinge unit 10 according to an embodiment of the present invention is applied.

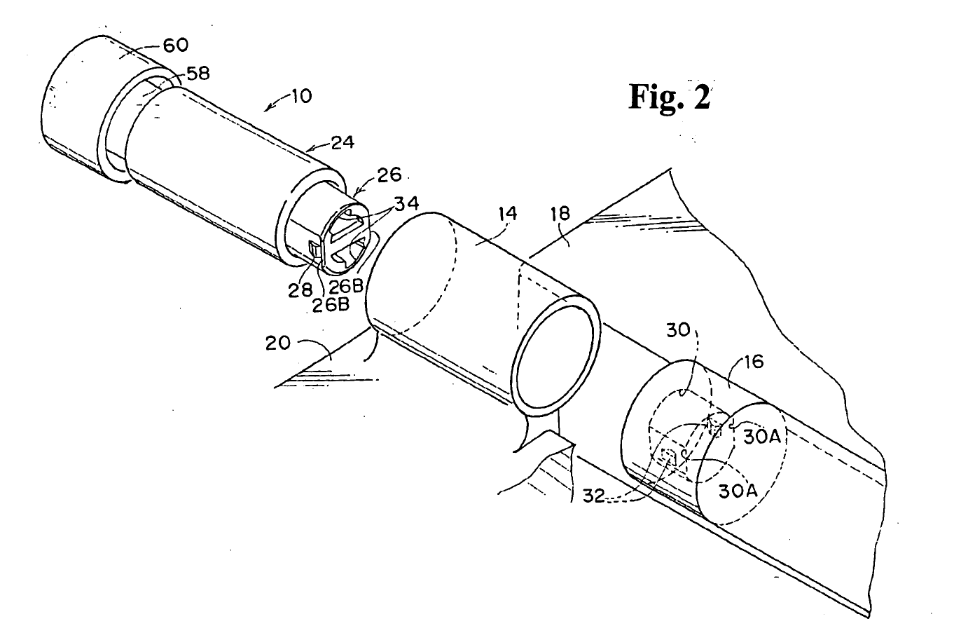

The mobile phone 12 is provided with a pair of axial portions 14 and 16 and a pair of axial portions 104 and 106. As shown in FIG. 2, the hinge unit 10 is provided at sides of the axial portions 14 and 16, and a receiver portion 18 is rotatable relative to a transmitter portion 20.

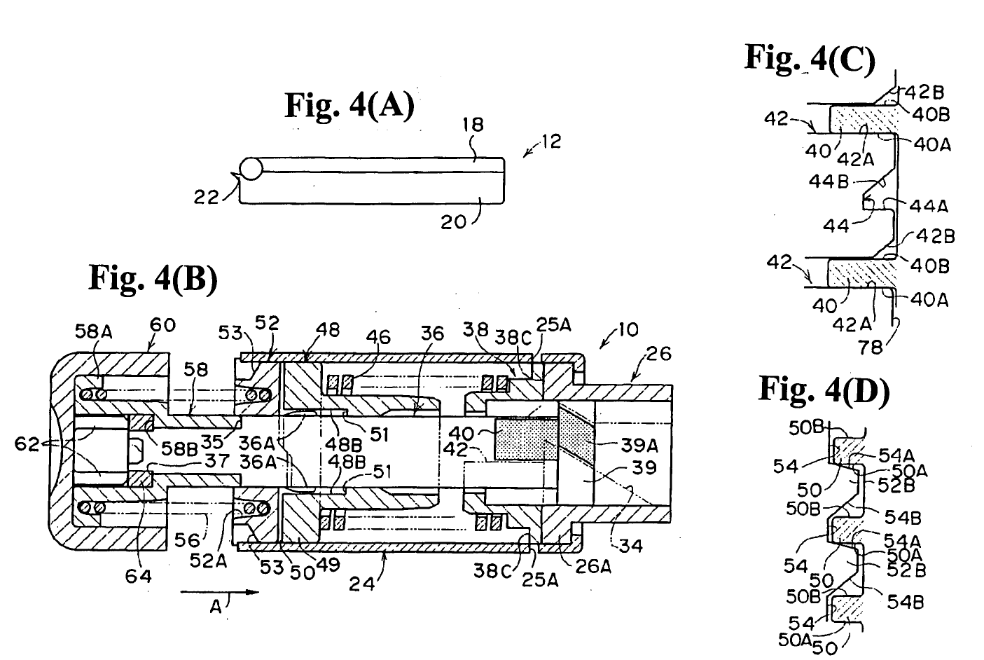

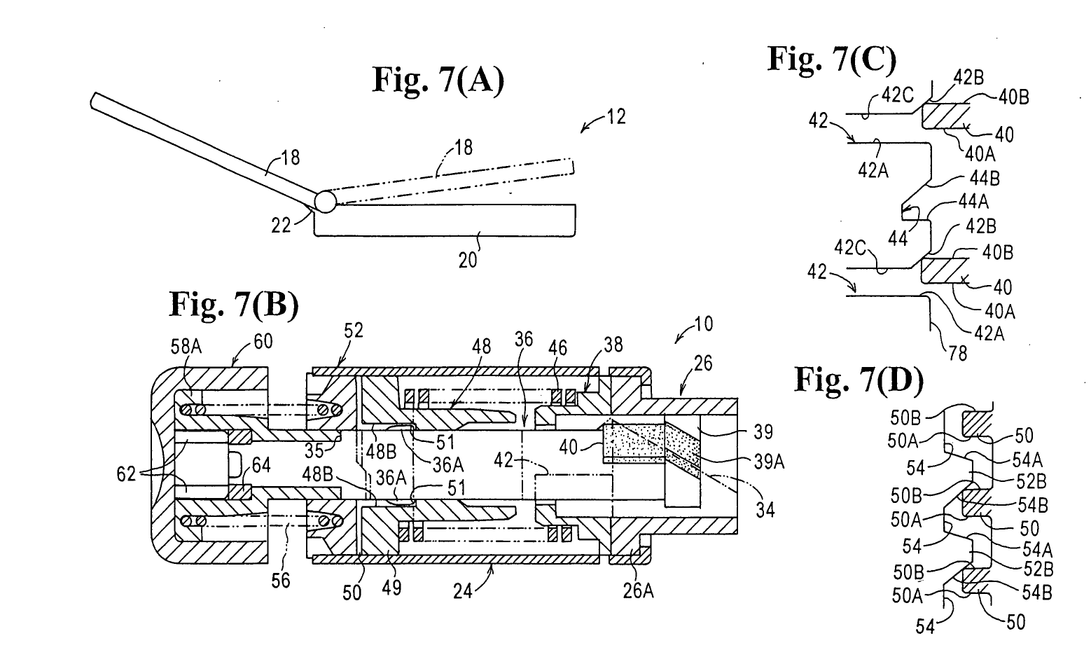

A stopper 22 is formed on a sidewall at a side of the axial portion 14 of the transmitter portion 20 for controlling an opening angle of the receiver portion 18 (refer to FIG. 4(A)). In a state that the receiver portion 18 abuts against the stopper 22, a rotation of the receiver portion 18 is restricted (refer to FIG. 7(A); in this case, an opening angle of the receiver portion 18 is 165°).

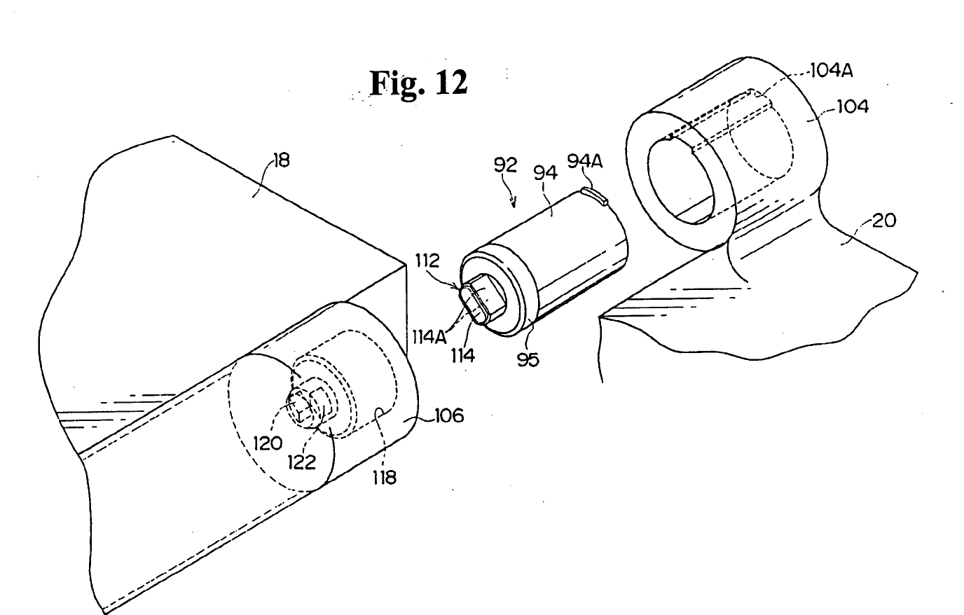

As shown in FIG. 12, a damper 92 is provided at a side of the axial portions 104 and 106 for controlling a rotational speed of the receiver portion 18 rotatable around the hinge unit 10.

Hereinafter, the hinge unit will be explained.

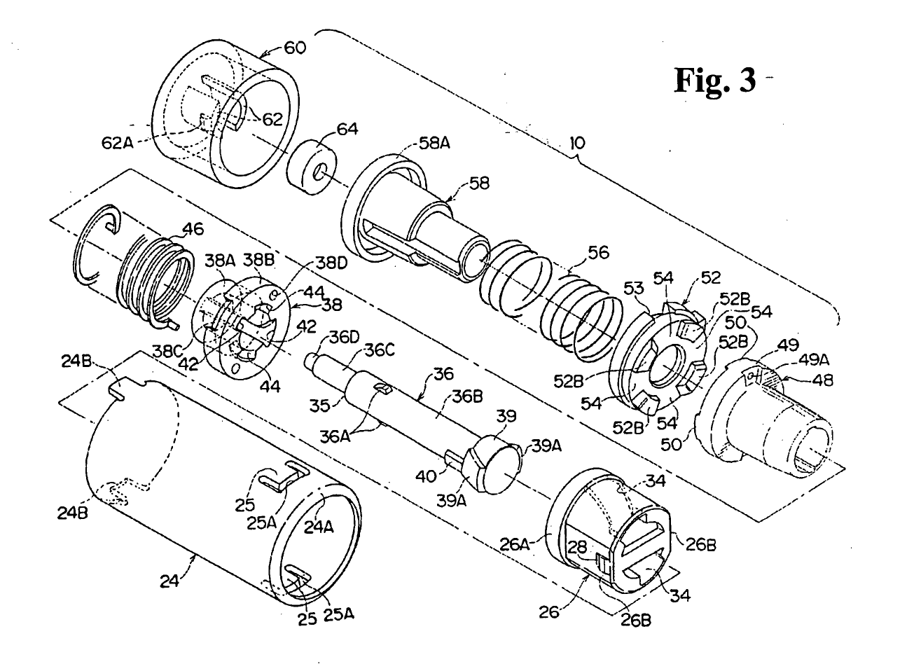

As shown in FIG. 3 and FIG. 4(B), in the hinge unit 10, a cylindrical case 24 is provided. One end of the case 24 is folded inwardly to form a shoulder portion 24A. A substantially cylindrical cam member 26 can pass through the case 24.

A flange portion 26A projects from one end of the cam member 26, and has an outer diameter substantially same as an inner diameter of the case 24. Accordingly, when the cam member 26 is inserted into the case 24, the flange portion 26A abuts against the shoulder portion 24A, so that the cam member 26 is restricted to move relative to the case 24.

Also, flat portions 26B are oppositely formed on an outer periphery surface of the cam member 26 along an axial direction, and a claw portion 28 projects on each of the flat portions 26B, respectively. As shown in FIG. 2, the axial portion 14 has a cylindrical shape and has an inner diameter substantially same as an outer diameter size of the case 24, so that the case 24 can be fixed to the axial portion 14.

As shown in FIG. 3, the axial portion 16 is provided with an attaching depression 30 making surface contact with an outer periphery surface of the cam member 26. The attaching depression 30 is provided with flat portions 30A, and projections 32 are formed on the flat portions 30A for engaging the claw portions 28.

When the cam member 26 is inserted into the attaching depression 30 and the claw portions 28 engage the projections 32, the cam member 26 is fixed in a state where the cam member 26 is not rotatable relative to the axial portion 16.

A pair of cam grooves 34 is formed in the inner periphery surface of the cam member 26 in a spiral shape along the axial direction of the cam member 26. A substantially cylindrical actuator 36 can be inserted into the cam member 26 as a rotational axis, and a cam portion 39 with a large diameter is provided in one end of the actuator 36.

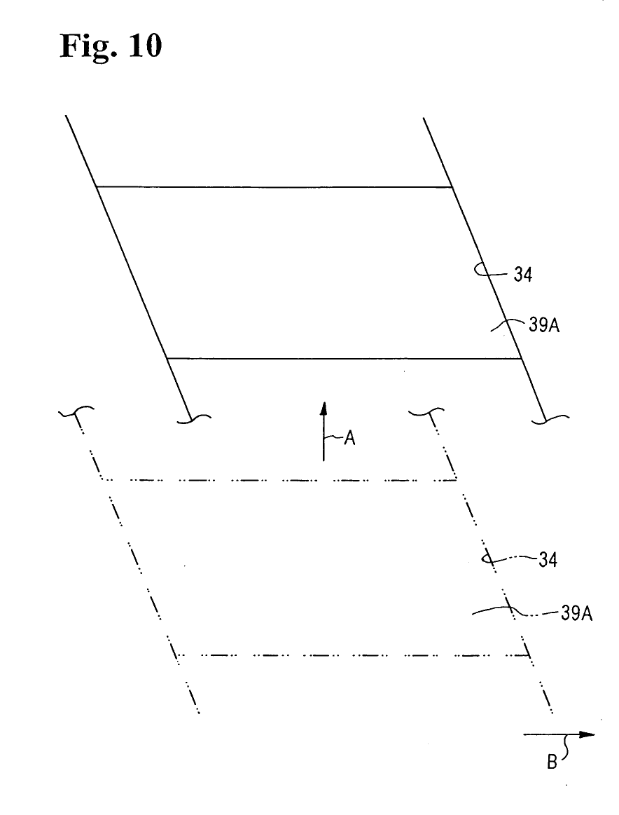

A pair of engaging projections 39A projects from the outer periphery surface of the cam portion 39 for engaging the cam grooves 34, respectively. As shown in FIG. 10, through the sliding of the actuator 36 (the arrow A direction), the cam member 26 rotates by approximately 7° in the opening direction of the receiver portion 18 (the arrow B direction) through the cam grooves 34 engaging the engaging projections 39A.

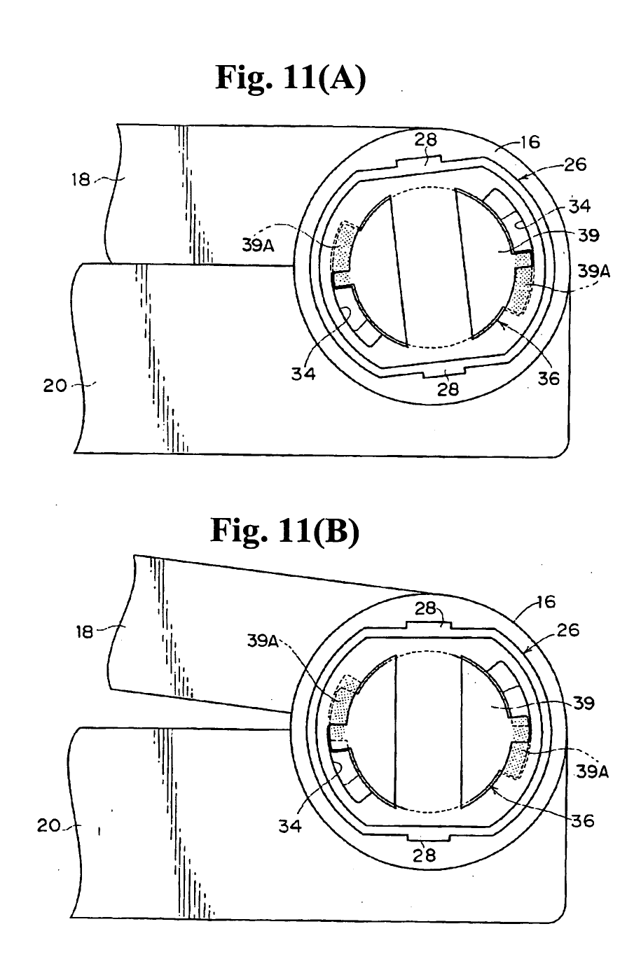

FIGS. 11(A) and 11(B) are views showing a state that the actuator 36 moves in a thickness direction of the drawing. An apparent movement of the actuator 36 can not be seen. In FIG. 11(A), the actuator 36 engages a rear side of the cam grooves 34 in the drawing, and the actuator 36 engages a front side of the cam grooves 34 in the drawing in FIG. 11(B). Accordingly, it is conceivable that the cam member 26 rotates through the cam grooves 34.

As shown in FIGS. 3 and 4(B), a substantially cylindrical stopper 38 having a small diameter portion 38A and a large diameter portion 38B can be fitted on the actuator 36. The large diameter portion 38B of the stopper 38 has an outer diameter substantially same as the inner diameter of the case 24, so that the stopper 38 can be fitted into the case 24.

Also, engaging grooves 42 and 44 are alternately formed at positions shifted by approximately 90° on the inner periphery surface of the stopper 38, so that a pair of key portions 40 projecting at one end of the actuator 36 along the axis direction of the actuator 36 can engage.

The engaging grooves 42 are formed from the large diameter portion 38B to the small diameter portion 38A, and face projections 36A projecting at the other end of the actuator 36, so that the stopper 38 can be fitted on the actuator 36. The engaging grooves 44 are formed at a side of the large diameter portion 38B and have a length long enough for a part of the key portions 40 to slightly engage.

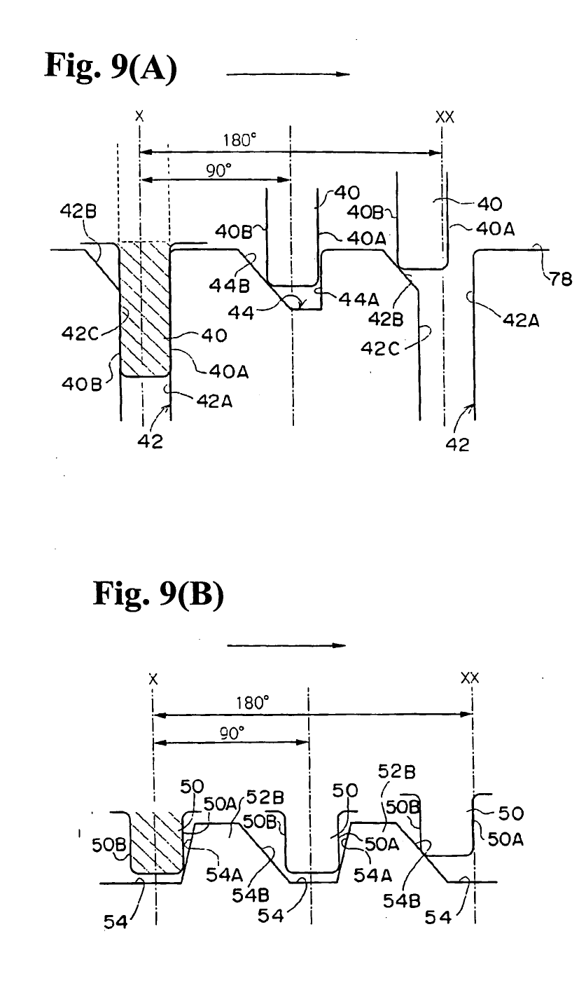

As shown in FIG. 9(A), the engaging grooves 42 and 44 are formed of sidewalls 42A and 44A corresponding to sidewalls 40A of the key portions 40 abutting in the opening direction (the arrow direction) of the receiver portion 18 as vertical walls formed in parallel to the sidewalls 40A of the key portions 40.

The engaging grooves 42 and 44 are also formed of sidewalls 42B and 44B corresponding to the sidewalls 40B of the key portions 40 abutting in the closing direction of the receiver portion 18 as inclined surfaces, so that the key portions 40 slide toward the rear side of the engaging grooves 44.

In the engaging grooves 42, sidewalls 42C are formed in parallel to the sidewalls 42A at the rear sides of the sidewalls 42B, so that the key portions 40 can be inserted between the sidewalls 42C and the sidewalls 42A.

As shown in FIGS. 3 and 4(B), depressions 38C are oppositely formed in the outer periphery surface of the large diameter portion 38B of the stopper 38, so that the engaging pieces 25 formed in one end of the case 24 can engage.

In the engaging pieces 25, substantially U-shaped and elastically deformable cutting portions 25A having openings at the other side of the case 24 are formed. When the stopper 38 is fitted on the actuator 36 and the depressions 38C of the stopper 38 engage the engaging pieces 25, the stopper 38 is fixed into the case 24.

As a result, in a state that the key portions 40 engage the engaging grooves 42 or 44 of the stopper 38, the actuator 36 can not rotate. In a state that the key portions 40 are disengaged from the engaging grooves 42 or 44, the actuator 36 can rotate.

In the large diameter portion 38B of the stopper 38, through-holes 38D are formed along the axial direction of the stopper 38, so that one end of a twisting coil spring 46 such as a spiral spring as the first urging means can be attached. A substantially cylindrical sub-cam 48 can be disposed to face the stopper 38, so that the other end of the twisting coil spring 46 can be mounted.

The sub-cam 48 has a size to be inserted into the case 24, and a cam portion 49 with a large diameter is formed at one end of the sub-cam 48. Engaging ribs 50 with a substantially cross-shape project from the end surface of the cam portion 49.

Also, through-holes 49A are formed in the cam portion 49 along the axial direction of the sub-cam 48, and the other end of the twisting coil spring 46 is mounted in the through-holes 49A. The twisting coil spring 46 urges the sub-cam 48 to separate from the stopper 38 and urges the receiver portion 18 to open. Accordingly, in a state where the receiver portion 18 is closed, an elastic force in the twisting direction is stored in the twisting coil spring 46.

Engaging grooves 48B are formed in the inner periphery surface of the sub-cam 48 along the axial direction of the sub-cam 48, so that the projections 36A of the actuator 36 can engage. Accordingly, the actuator 36 rotates with the sub-cam 48.

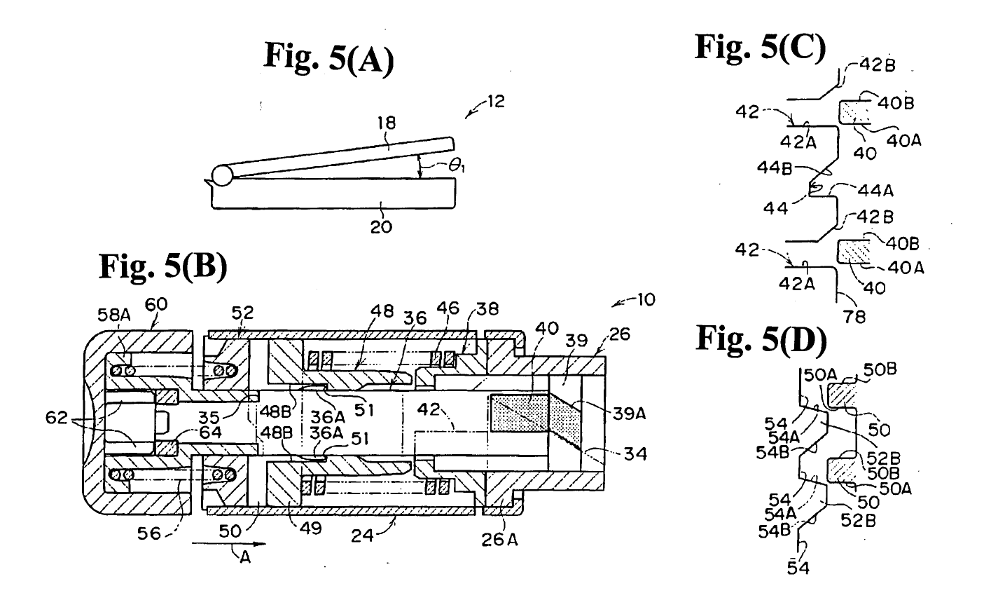

Here, wall portions 51 are formed in the engaging grooves 48B, so that the projections 36A can abut against. Accordingly, the actuator 36 can slide for a predetermined distance relative to the sub-cam 48. In the state where the projections 36A of the actuator 36 abut against the wall portions 51 of the sub-cam 48 (refer to FIG. 5(B)), the projections 36A slide with the sub-cam 48.

On the other hand, a substantially cylindrical cap 52 can abut against the sub-cam 48. One end of the cap 52 has an external diameter substantially same as the internal diameter of the case 24, and the other end of the cap 52 has a diameter larger than that of the one end of the cap 52. That is, in the state where the one end of the cap 52 is fitted into the case 24, the other end of the cap 52 abuts against the end surface of the case 24 to close the other end of the case 24.

Furthermore, engaging depressions 54 are formed on the one end surface of the cap 52 along the periphery direction at positions shifted by 90° for engaging the engaging ribs 50 of the cam portion 49, so that the engaging ribs 50 engage or are disengaged from the engaging depressions 54 when the sub-cam 48 rotates.

As shown in FIG. 9(B), sidewalls of the engaging depressions 54 against which the engaging ribs 50 of the sub-cam 48 can abut are composed of substantially standing walls and inclined surfaces. Sidewalls 54A of the engaging depressions 54 corresponding to sidewalls 50A of the engaging ribs 50 abutting in the opening direction (direction of the arrow) of the receiver portion 18 are substantially standing walls formed substantially in parallel to the sidewalls 50A of the engaging ribs 50 of the sub-cam 48.

Also, sidewalls 54B of the engaging depressions 54 corresponding to sidewalls 50B of the engaging ribs 50 of the sub-cam 48 abutting in the closing direction of the receiver portion 18 are inclined surfaces so that the engaging ribs 50 slide toward the rear side of the engaging depressions 54.

On the other hand, as shown in FIGS. 3, 4 (B), a pair of notched portions 53 is cut at the other end of the cap 52. A pair of extending pieces 24B extending along the axial direction of the case 24 from the other end of the case 24 can engage the notched portions 53. In the state where the extending pieces 24B face the notched portions 53, the extending pieces 24B turn down inwardly to engage the notched portions 53.

Accordingly, the cap 52 is locked not to rotate and positioned relative to the axial direction of the case 24. A circular depression 52A is formed in the other end surface of the cap 52, so that one end of the coil spring 56 can be mounted.

On the other hand, attaching portions 36C and 36D with diameters smaller than that of the axial portion 36B are formed respectively at the other end of the actuator 36. The attaching portion 36C has a diameter larger than that of the attaching portion 36D.

The attaching portion 36C can be fitted on a substantially cylindrical joint 58. The joint 58 is united with the actuator 36 in the state where one end surface of the joint 58 abuts against an abutting portion 35 composed of the axial portion 36B and the attaching portion 36C.

A circular pedestal 58A is formed at the other end of the joint 58, and has a peripheral wall standing from an outer edge thereof toward one end of the joint 58. The other end of the coil spring 56 can be mounted to the pedestal 58A for urging in a direction where the joint 58 separates from the cap 52.

A cylindrical button portion 60 with an opening end can be fitted on the pedestal 58A of the joint 58. A pair of arc pieces 62 projects from the middle of a bottom of the button portion 60, and engaging claws 62A project at an upper outer surface of the arc pieces 62.

A locking portion (not shown) is formed on the inner periphery surface of the joint 58, so that the engaging claws 62A can engage. With this configuration, when the pedestal 58A of the joint 58 is fitted on the button portion 60, the engaging claws 62A of the button portion 60 engage the locking portion, so that the joint 58 and the button portion 60 are united.

Here, the coil spring 56 urges in the direction that the button portion 60 separates from the cap 52 through the joint 58, and when the button portion 60 is pressed, the coil spring 56 is compressed to restore the elastic force.

Incidentally, a circular receiving portion 58B is formed in the inner periphery surface of the joint 58 along the periphery direction of the joint 58, and has a height substantially same as that of the abutting portion 37 composed of the attaching portions 36C and 36D of the actuator 36.

The attaching portion 36D is fitted into a collar 64, and the abutting portion 37 faces and contacts the receiving portion 58B. With this configuration, the pressing force from the button portion 60 can be reliably transmitted to the actuator 36.

A damper will be explained next.

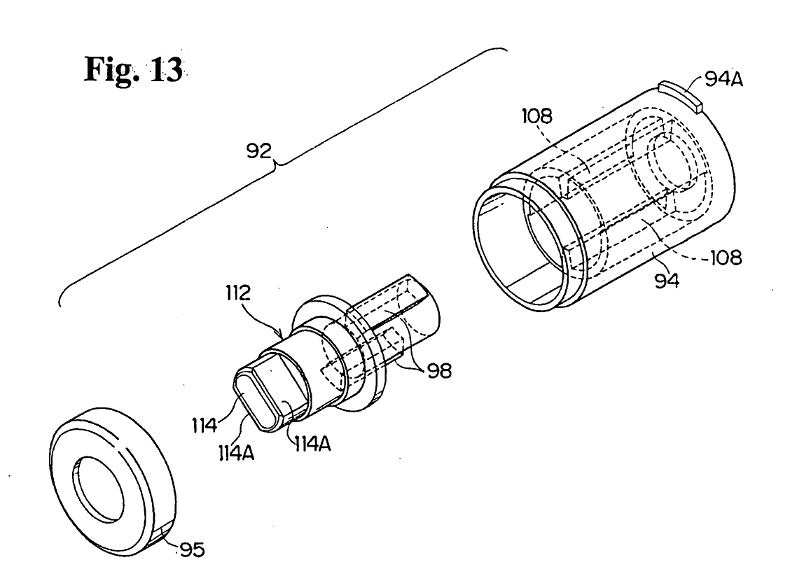

As shown in FIGS. 12 and 13, axial portions 104 and 106 have a substantially cylindrical shape. The axial portion 106 is provided in the receiver portion 18 and the axial portion 104 is provided in the transmitter portion 20. The substantially column-shaped damper 92 can be fixed into the axial portion 104.

A projection 94A is formed on the outer periphery surface of one end of a housing 94 of the damper 92 for engaging a groove 104A formed in the inner periphery surface of the axial portion 104 along the axial direction, and is fixed into the axial portion 104 not to rotate relative to the axial portion 104.

A ring-shaped lid member 95 is fixed to the other end of the housing 94, and one end of a shaft 112 is exposed from the middle of the lid member 95. The shaft 112 is rotatably supported on the housing 94, and a pair of wing portions 98 projects from an outer periphery surface of the shaft 112 at the other end of the shaft 112.

The housing 94 is filled with viscous fluid such as silicon oil having a high viscosity. When the shaft 112 rotates, the wing portions 98 stir the viscous fluid. In other words, the viscous fluid applies viscous resistance on the shaft 112 through the wing portions 98.

Here, an abutting portion 114 is provided at the exposed part of the shaft 112. The abutting portion 114 has a substantially oval shape, and flat surface portions 114A are formed on surfaces corresponding to long axial sides of the oval shape.

On the other hand, a cylindrical depression 118 is formed in a bottom surface of the axial portion 106, so that the abutting portion 114 can be inserted into the cylindrical depression 118. A pair of abutting projections 120 and 122 projects from the inner periphery surface of the cylindrical depression 118 toward the axial center.

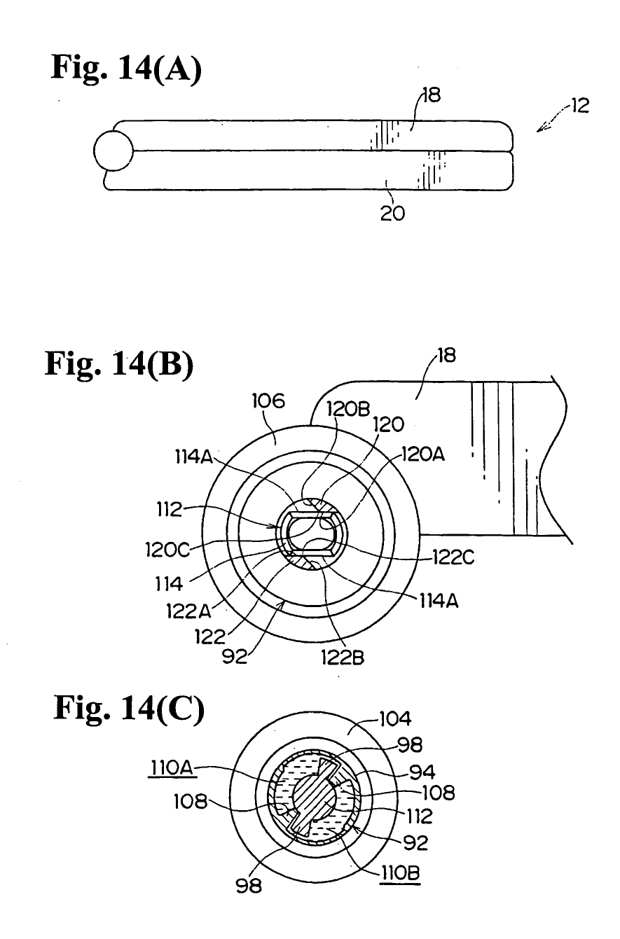

The abutting projections 120 and 122 are substantially triangular prisms. As shown in FIG. 14(B), an abutting surface 120A of the abutting projection 120 and an abutting surface 122A of the abutting projection 122 are formed to be in parallel, and an abutting surface 120B of the abutting projection 120 and an abutting surface 122B of the abutting projection 122 are formed to be in parallel.

Here, a distance between the abutting surfaces 120A and 122A or between the abutting surfaces 120B and 122B is substantially the same as a width of the abutting portion 114 (distance between the flat surface portions 114A).

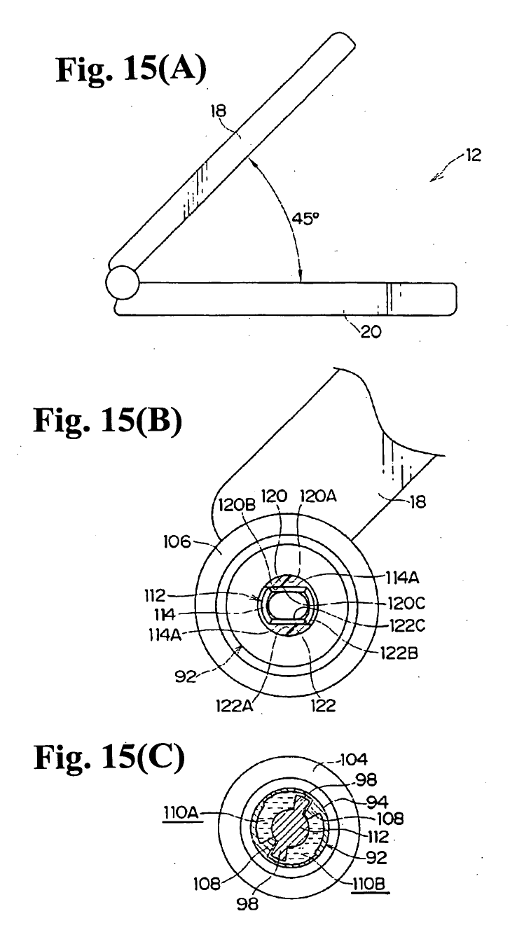

A length of the abutting surfaces 120A, 120B, 122A and 122B (projecting amount from the inner periphery surface of the cylindrical depression 118) of the abutting projections 120 and 122 projecting from the inner periphery surface of the cylindrical depression 118 (refer to FIG. 12) is approximately one half of a length of the flat surface portion 114A. As shown in FIGS. 14(B) and 15(B), the abutting surfaces 120A and 122A, or 120B and 122B can abut against the flat surface portions 114A.

A relationship between the abutting portion 114 and the abutting projections 120 and 122 will be explained next.

As shown in FIGS. 14(A) to 14(C), in a state where the receiver portion 18 is closed relative to the transmitter portion 20, the abutting surfaces 120A and 122A abut against the flat surface portions 114A of the abutting portion 114.

Next, as shown in FIGS. 15(A) to 15(C), when the receiver portion 18 is opened by 45° relative to the transmitter portion 20, the axial portion 106 rotates with the receiver portion 18. Positions of the abutting projections 120 and 122 relative to the abutting portion 114 are changed, and the abutting surfaces 120B and 122B abut against the flat surface portions 114A of the abutting portion 114.

That is, during 0° to 45° of the opening angle, only top portions 120C and 122C of the abutting projections 120 and 122 abut against the central parts of the flat surface portions 114A, so that the shaft 112 does not rotate (so-called idle run or idle rotation).

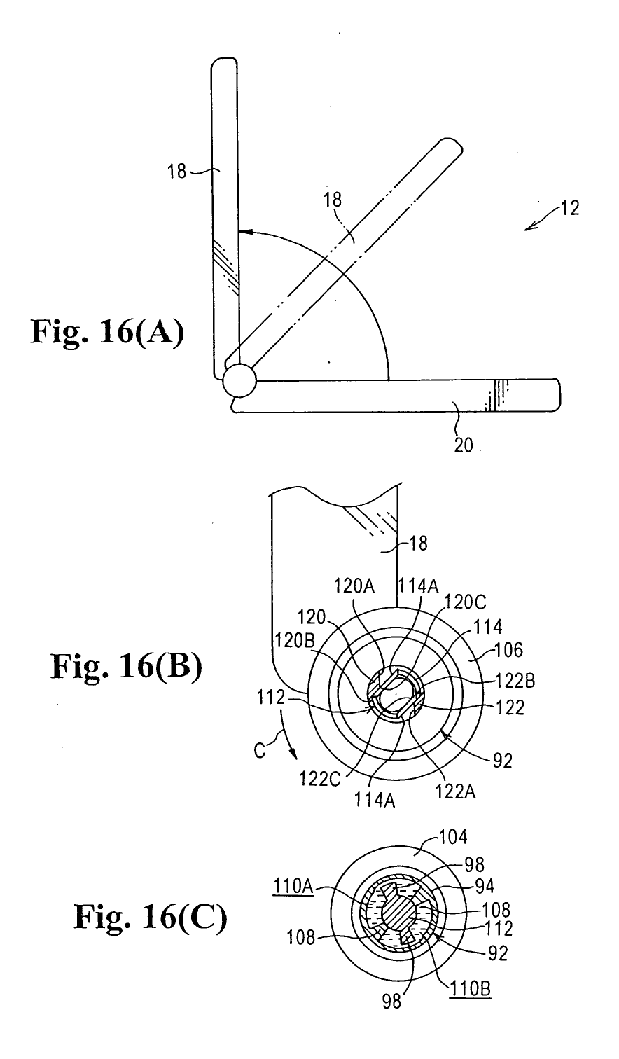

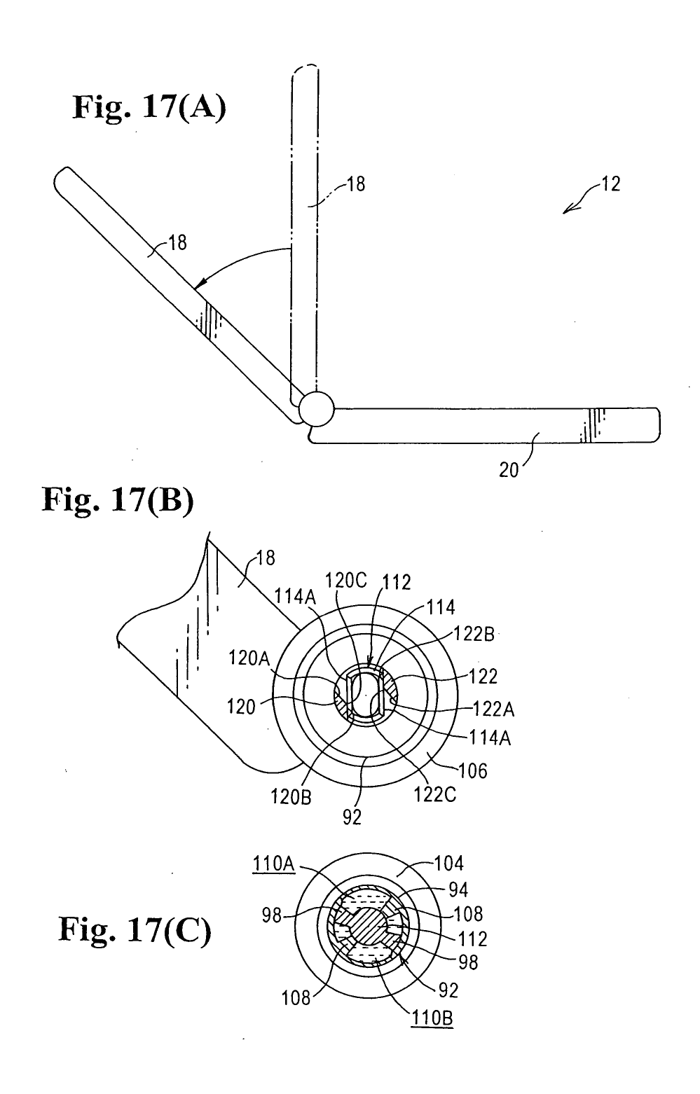

On the other hand, as shown in FIGS. 16(A) to 18(C), when the receiver portion 18 opens wider than 45° relative to the transmitter portion 20, the flat surface portions 114A are pressed in the direction of the arrow C by the abutting projections 120 and 122 in the state where the abutting surfaces 120B and 122B abut against the flat surface portions 114A of the abutting portion 114. Accordingly, the shaft 112 rotates through the flat surface portions 114A.

As a result, the wing portions 98 stir the viscous fluid in the housing 94 of the damper 92, and the shaft 112 receives the viscous resistance of the viscous fluid through the wing portions 98, so that a braking force is applied on the receiver portion 18 through the axial portion 106.

A relationship between the wing portions 98 and the inner periphery surface of the housing 94 will be explained next.

As shown in FIG. 14(C), a pair of dividing walls 108 projects from the inner periphery surface of the housing 94 along the axial direction for dividing the inside of the housing 94 into two liquid chambers 110A and 110B.

There is a gap between the end surface of each dividing wall 108 and the outer periphery surface of the shaft 112. The liquid chambers 110A and 110B communicate with each other through the gaps, so that the viscous fluid can pass therethrough.

On the other hand, the housing 94 has a variable wall thickness to change the gap between the inner periphery surface of the housing 94 and the end of each wing portion 98 of the shaft 112. More specifically, the gap is wide until the wing portion 98 rotates by a predetermined angle (in this case, 45°), and the gap becomes narrow when the wing portion 98 rotates greater than 45°.

An operation of opening the mobile phone 12 will be explained next.

As shown in FIGS. 4(A) to 4(D), at a side of the hinge unit 10, in a state that the receiver portion 18 is closed relative to the transmitter portion 20, the twisting force is stored in the twisting coil spring 46. The key portions 40 of the actuator 36 engage the engaging grooves 42 of the stopper 38. At the same time, the engaging ribs 50 formed in the cam portion 49 of the sub-cam 48 engage the engaging depressions 54 of the cap 52, so that the rotation of the actuator 36 is restrained.

As shown in FIGS. 5(A) to 5(D), when the button portion 60 projecting from the left side surface of the receiver portion 18 is pressed, the button portion 60 moves in the direction against the force of the coil spring 56 (the arrow direction A). At the same time, the joint 58 and the actuator 36 slide inside the case 24 in the arrow direction A along the axial direction through the button portion 60.

When the actuator 36 slides for the predetermined distance, the sub-cam 48 moves in the direction that the sub-cam 48 approaches toward the stopper 38 through the projections 36A of the actuator 36 (direction against a force of the twisting coil spring 46, i.e. compressive direction).

Also, through the sliding of the actuator 36, the key portions 40 of the actuator 36 slide inside the engaging grooves 42 of the stopper 38. At the same time, the engaging depressions 39A of the cam portion 39 of the actuator 36 slide along the cam grooves 34 formed in the cam member 26 to rotate the cam member 26 and the receiver portion 18 where the cam member 26 is fixed to open by θ1 (θ1 is smaller than 7°).

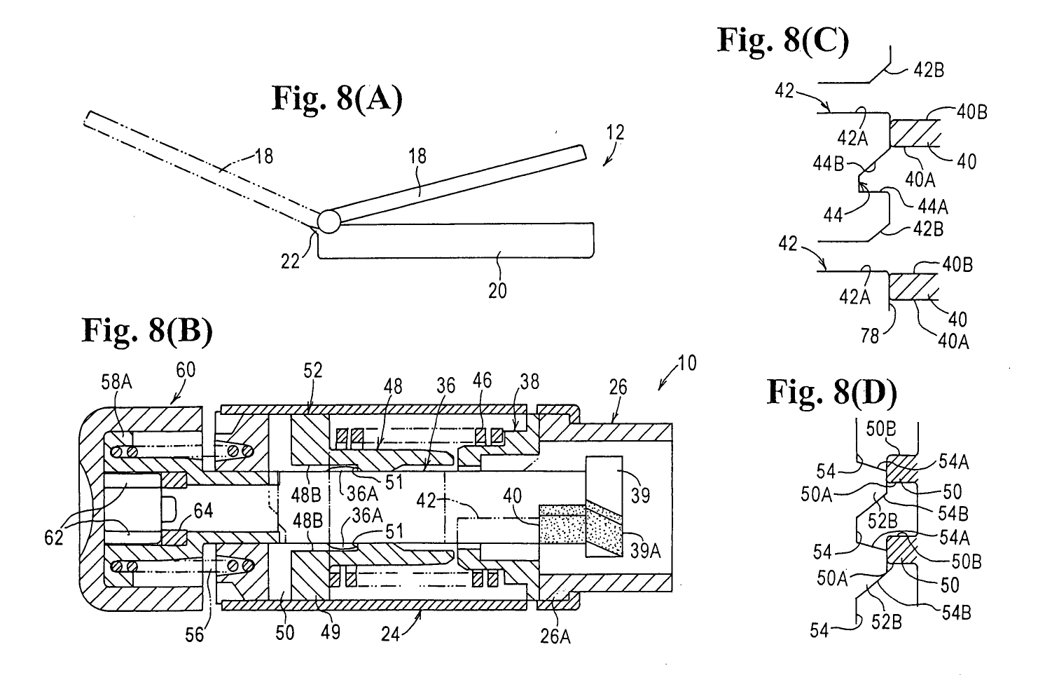

When the key portions 40 of the actuator 36 come off the engaging grooves 42 of the stopper 38 and the actuator 36 is released from the stopper 38, as shown in FIGS. 8(A) to 8(D), the actuator 36 can rotate.

As a result, with the restoring force (urging force) of the twisting coil spring 46 where the elastic force is stored, the actuator 36 rotates relative to the case 24 through the sub-cam 48. At the same time, the cam member 26 rotates together with the actuator 36 and the receiver portion 18 further opens.

When the receiver portion 18 rotates in the opening direction, the end surfaces of the key portions 40 abut against all of the top surface (hereinafter referred to as a “cam surface 78”) of the stopper 38 and slide on the cam surface 78. In the sub-cam 48, the engaging ribs 50 slide on the top surfaces of the projections 52B of the cap 52.

As a result, in the receiver portion 18, a braking force is obtained through frictional resistance between the cam surface 78 and the key portions 40, and between the engaging ribs 50 and the top surfaces of the projections 52B, so that the receiver portion 18 opens quietly.

On the other hand, as shown in FIGS. 8(B) to 8(D), in the state where the key portions 40 abut against all of the cam surface 78, the compressive force is stored in the coil spring 56 and the twisting coil spring 46.

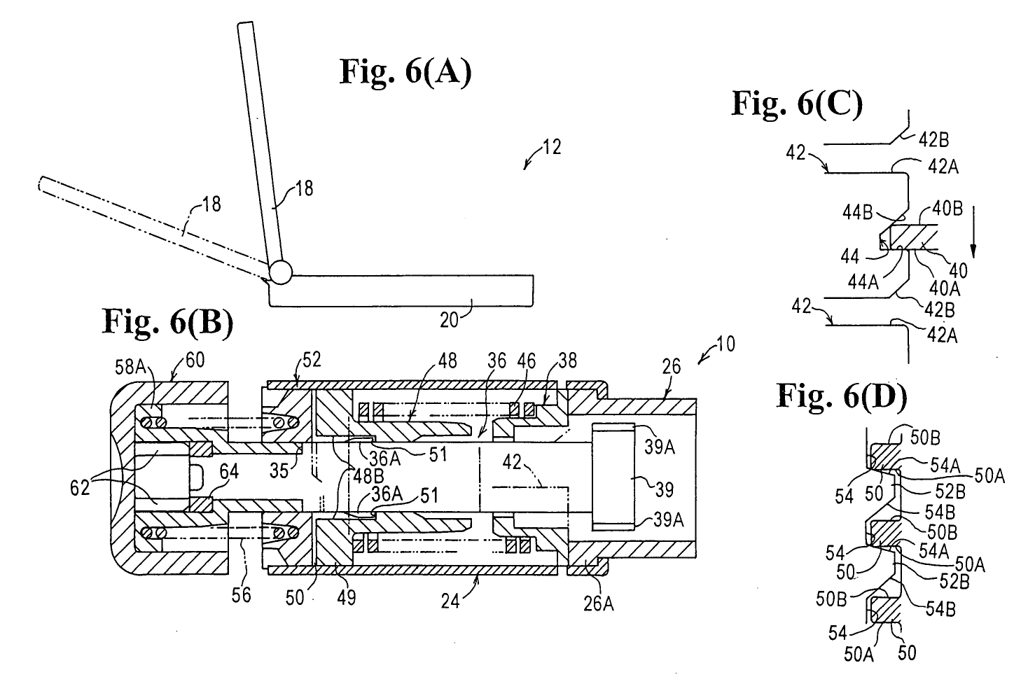

As a result, as shown in FIGS. 6(A) to 6(D), when the key portions 40 reach the engaging grooves 44 of the cam surface 78, the key portions 40 engage the engaging grooves 44 with the restoring force of the coil spring 56.

Accordingly, in the state where the key portions 40 engage the engaging grooves 44, edge parts of the sidewalls 40B of the key portions 40 abut against the sidewalls 44B of the engaging grooves 44, and the sidewalls 40A of the key portions 40 are pressed against the sidewalls 44A of the engaging grooves 44 with the force of the twisting coil spring 46. In the sub-cam 48, the sidewalls 50A of the engaging ribs 50 are pressed against the sidewalls 54A of the engaging depressions 54 with the force of the twisting coil spring 46.

Here, when the key portions 40 engage the engaging grooves 44, the sidewalls 40A of the key portions 40 abut against the sidewalls 44A of the engaging grooves 44 in the opening direction of the receiver portion 18, and then the edge parts of the sidewalls 40B of the key portions 40 abut against the sidewalls 44B of the engaging grooves 44.

In the engaging ribs 50, when the engaging ribs 50 engage the engaging depressions 54, the sidewalls 50A of the engaging ribs 50 abut against the sidewalls 54A of the engaging depressions 54 in the opening direction of the receiver portion 18.

Through the engagements between the key portions 40 and the engaging grooves 44, and between the engaging ribs 50 and the engaging depressions 54, it is possible to maintain the state where the receiver portion 18 opens by a predetermined angle (in this case, 97°).

Here, the sidewall 54A (substantially standing wall) of each engaging depression 54 is inclined by approximately 1 degree relative to the vertical wall, so that even when there is a difference in dimensions in the periphery direction among the actuator 36, the sub-cam 48, the stopper 38, and the cap 52, the difference can be absorbed.

Accordingly, when the button portion 60 is pressed again in the state where the receiver portion 18 opens at the predetermined angle, the actuator 36 slides and moves, and the key portions 40 of the actuator 36 are released from the engaging grooves 42 of the stopper 38.

Accordingly, through the force of the twisting coil spring 46, the actuator 36 further rotates in the state where the key portions 40 abut against the cam surface 78 (the receiver portion 18 further opens). Through the rotation of the actuator 36, the engaging ribs 50 of the cam member 49 of the sub-cam 48 are released from the engaging depressions 54 of the cap 52.

And, as shown in FIGS. 7(C) and 7(D), when the key portions 40 reach the engaging grooves 42 of the cam surface 78, the key portions 40 engage the engaging grooves 42 with the restoring force of the coil spring 56.

Here, in the engaging grooves 42, the sidewalls 42C in parallel to the sidewalls 42A are provided at the rear sides of the sidewalls 42B, and the key portions 40 can be inserted between the sidewalls 42C and the sidewalls 42A. Accordingly, edge parts of the sidewalls 40B of the key portions 40 are guided by the sidewalls 42B of the engaging grooves 42, and the key portions 40 are guided to the rear sides of the engaging grooves 42.

Incidentally, before the sidewalls 40A of the key portions 40 abut against the sidewalls 42A of the engaging groves 42, a back surface of the receiver potion 18 abuts against the stopper 38 of the transmitter portion 20, so that the urging force of the twisting coil spring 46 is locked in the state where the back surface of the receiver portion 18 abuts against the stopper 38 of the transmitter portion 20. With the restoring force of the compression force of the coil spring 56, the key portions 40 are urged to the rear side of the engaging grooves 42 in the state where the edge parts of the sidewalls 40B of the key portions 40 abut against the sidewalls 40B.

The engaging ribs 50 formed in the cam member 49 of the sub-cam 48 engage the engaging depressions 54 of the cap 52. In the engaging ribs 50, corners of the sidewalls 50B of the engaging ribs 50 abut against the sidewalls 54B of the engaging depressions 54, and the twisting coil spring 46 urges the engaging ribs 50 toward the rear sides of the engaging depressions 54.

Thus, it is possible to maintain the state where the receiver portion 18 fully opens through the engagement between the key portions 40 and the engaging grooves 44, and between the engaging ribs 50 and the engaging depressions 54. In the state where the receiver portion 18 fully opens, as shown in FIGS. 7(B) and 7(C), a driving force to slide and move the actuator 36 is applied with the restoring force of the coil spring 56, and is converted to the rotational force to rotate the cam member 26 in the direction where the receiver portion 18 opens, so that even if the mobile phone 12 is shaken when the receiver portion 18 fully opens, the receiver portion 18 does not wobble.

Incidentally, in the damper 92, as shown in FIGS. 14(A) and 14(B), the abutting projections 120 and 122 provided at the axial portion 106 rotate with the rotation of the receiver portion 18, and in the state where the top portions 120C and 122C of the abutting projections 120 and 122 abut against the central parts of the flat surface portions 114A of the abutting portion 114 of the damper 92 provided in the axial portion 104, the abutting projections 120 and 122 change positions. As a result, the shaft 112 stays not to move, and the braking force of the damper 92 does not act on the receiver portion 18.

As shown in FIGS. 15(A) and 15(B), when the opening angle of the receiver portion 18 becomes 45°, the abutting surfaces 120B and 122B of the abutting projections 120 and 122 abut against the flat surface portions 114A of the abutting portion 114 of the damper 92.

By rotating the shaft 112 in the state where the abutting surfaces 120B and 122B of the abutting projections 120, 122 abut against the flat surface portions 114A of the abutting portion 114 of the damper 92, the braking force of the damper 92 is applied.

As shown in FIGS. 16(A) to 16(C), after the receiver portion 18 opens greater than 45°, the abutting projections 120, 122 press the flat surface portions 114A in the arrow direction C to rotate the shaft 112 through the flat surface portions 114A.

Accordingly, the wing portions 98 of the damper 92 stir the viscous fluid inside the housing 94 and the shaft 112 receives the viscous resistance of the viscous fluid through the wing portions 98, so that the braking force is applied on the receiver portion 18 through the axial portion 106.

With the structure described above, when the receiver portion 18 opens from 0° to 45°, the receiver portion 18 opens quietly with the braking force through the frictional resistance between the cam surface 78 of the stopper 38 of the hinge unit 10 and the key portions 40 of the actuator 36, and between the engaging ribs 50 of the sub-cam 48 and the top surfaces of the projections 52B of the cap 52.

When the receiver portion 18 opens from 45° to 165° (fully opened position), the receiver portion 18 opens slowly with the braking force through the frictional resistance between the cam surface 78 of the hinge unit 10 and the key portions 40, and between the engaging ribs 50 and the top surfaces of the projections 52B, and the braking force through the viscous resistance of the damper 92. When the receiver portion 18 is stopped opening, no impact is received.

On the other hand, in the damper 92, the housing 94 has the various wall thickness, so that the gap between the end of each wing portion 98 of the shaft 112 is changed, and is wide until the wing portions 98 rotate by 45° (the opening angle of the receiver portion 18 is approximately 90°), and becomes narrow when the wing portions 98 rotate more than 45°.

As a result, after the receiver portion 18 opens greater than 90°, the compressive resistance between the end of each wing portion 98 and the inner periphery surface of the housing 94 is increased, so that an increase in the rotational speed due to its own weight of the receiver portion 18 and a force of the twisting coil spring 46 is limited.

An operation of closing the mobile phone 12 will be explained next.

As shown in FIGS. 8(A) and 8(B), at the side of the hinge unit 10, the fully opened receiver portion 18 is rotated in the closing direction relative to the transmitter portion 20. At this time, the actuator 36 and the sub-cum 48 rotate in reverse through the cam member 26, and the twisting force is stored in the twisting coil spring 46.

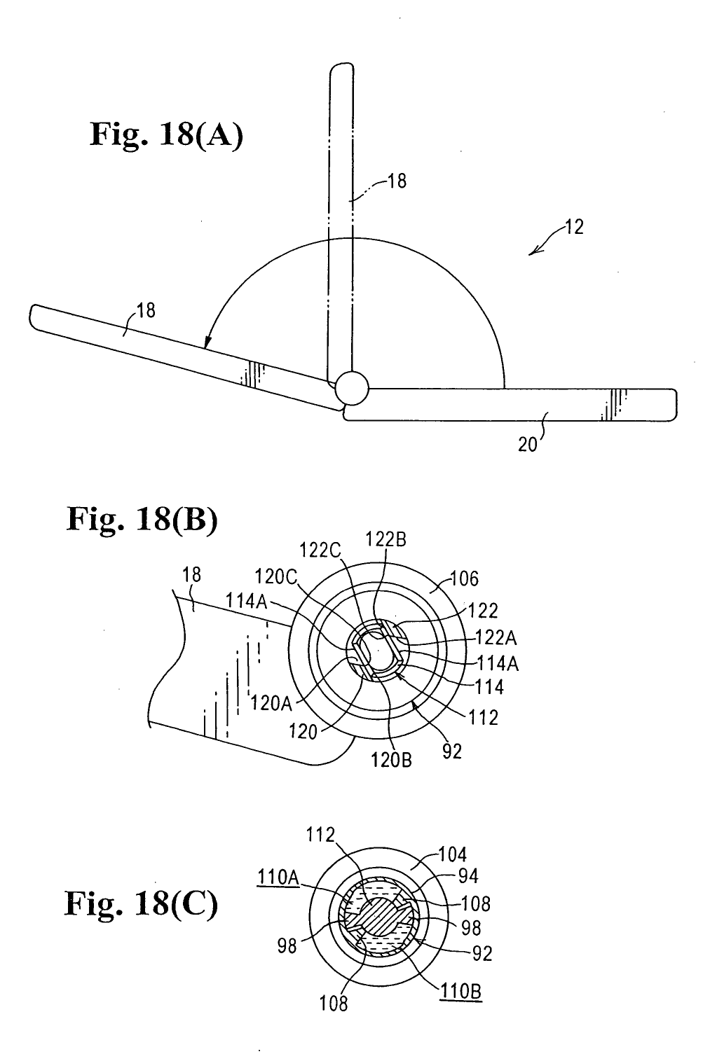

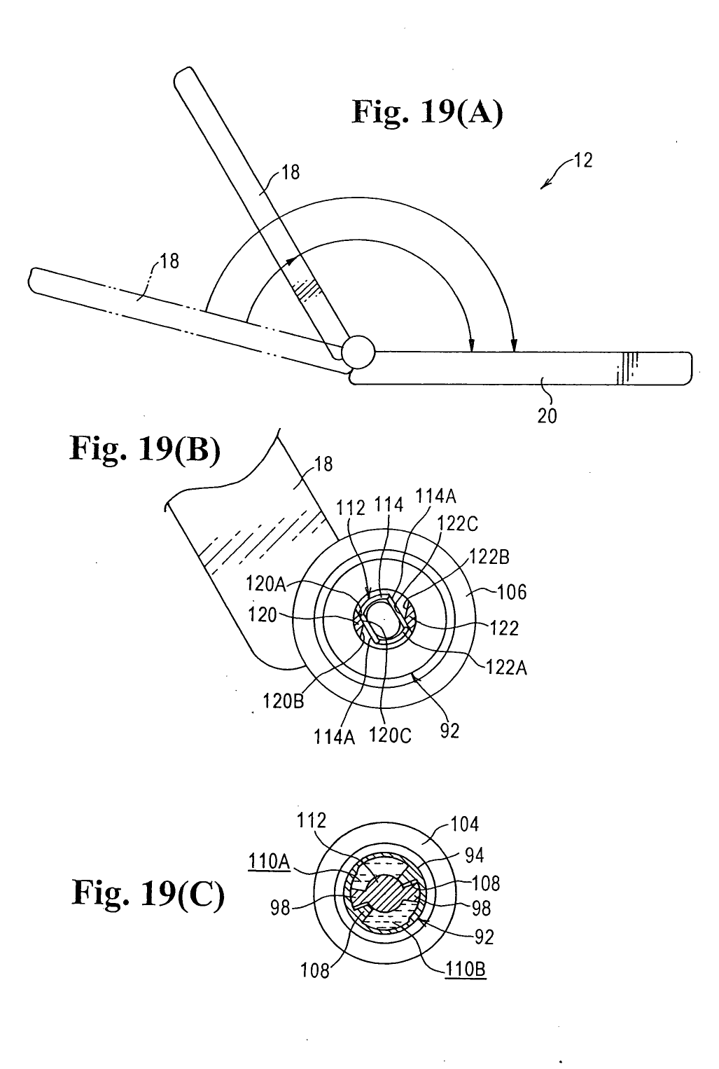

On the other hand, as shown in FIGS. 18(A) to 18(C), in the damper 92, the abutting surfaces 120B and 122B of the abutting projections 120, 122 abut against the flat surface portions 114A of the abutting portion 114 of the damper 92. As shown in FIGS. 19(A) to 19(C), while the abutting surfaces 120A and 122A of the abutting projections 120 and 122 abut against the flat surface portions 114A of the abutting portion 114 of the damper 92 (the receiver portion 18 closes at 45° from the full-opened position), only the abutting projections 120 and 122 change their positions in the state where the top portions 120C and 122C of the abutting projections 120, 122 abut against the central parts of the flat surface portions 114A of the abutting portion 114 of the damper 92, and the shaft 112 stays not to move. As a result, the braking force of the damper 92 is not acted on the receiver portion 18.

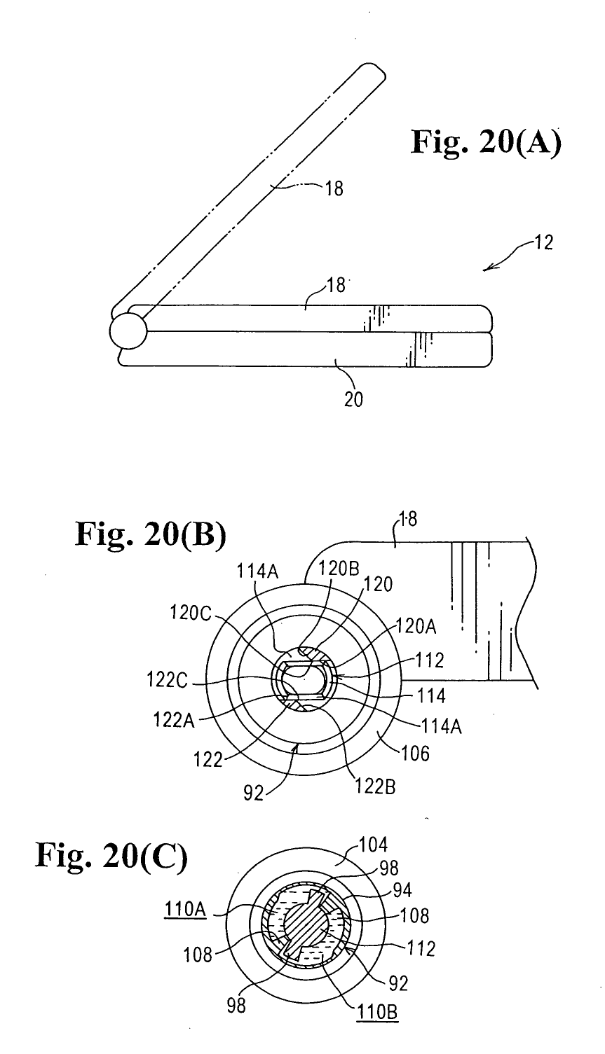

From the state shown in FIGS. 19(A) and 19(B) to the state shown in FIGS. 20(A) and 20(B) that the receiver portion 18 is closed, the abutting projections 120 and 122 press the flat surface portions 114A in the arrow direction D to rotate the shaft 112 through the flat surface portion 114A in the state where the abutting surfaces 120A and 122A of the abutting projections 120, 122 abut against the flat surface portions 114A of the abutting portion 114 of the damper 92. As a result, the braking force is applied to the receiver portion 18 through the viscous resistance of the damper 92.

The distance between the end of each wing portion 98 and the inner periphery surface of the housing 94 becomes large in FIG. 20(C) compared to FIG. 19(C). Accordingly, due to the large distance between the end of each wing portion 98 and the inner periphery surface of the housing 94, the compressive resistance is reduced. As a result, the force applied on the wing portions 98 is reduced and the braking force of the damper 92 is reduced.

On the other hand, as shown in FIGS. 5(B) and 5(C), when the key portions 40 of the actuator 36 reach the position to be able to engage the engaging grooves 42 of the stopper 38, the actuator 36 is pulled back with the restoring force of the coil spring 56, and the button portion 60 is pulled back to the original position through the joint 58.

Here, through the sliding of the actuator 36, the cam member 26 rotates in the closing direction, and the key portions 40 of the actuator 36 engage the engaging grooves 42, so that the rotation of the cam member 26 is restrained and the receiver portion 18 is closed.

As shown in FIGS. 4(B) and 4(C), in the state where the receiver portion 18 is closed, the force is applied to the actuator 36 to slide with the restoring force of the coil spring 56, and is converted to the rotational force to rotate the cam member 26 in the direction where the receiver portion 18 is closed, so that even if the mobile phone 12 is shaken in the fully closed state, the receiver portion 18 does not wobble.

A function of the hinge structure with the hinge unit will be explained next.

As shown in FIGS. 3, 9(A), by proving the engaging grooves 44 in the stopper 38 in addition to the engaging grooves 42 for engaging the key portions 40 of the actuator 36, it is possible to stop the receiver portion 18 in the middle of the process of reaching the fully opened position.

Incidentally, here, the engaging grooves 44 are disposed corresponding to the positions of the key portions 40 when the actuator 36 rotates by approximately 90°, so that when the button portion 60 is pushed just once, it is possible to stop the receiver portion 18 at not only the full-opened position (approximately 165°), but also at approximately 90°.

When the mobile phone 12 includes a timer function with a self-timer, the mobile phone 12 needs to be placed on a table in a state where the receiver portion 18 is opened approximately 90°. It is convenient to open and stop the receiver portion 18 at approximately 90° by pushing the button portion 60 just once. In shooting a photo, it is preferable to set the open angle of the receiver portion at 93° to 97°, so that the table does not block and a wide range is obtained.

On the other hand, the twisting coil spring 46 applies the torsional force to the sub-cam 48 and the actuator 36 to press the button portion 60 in the direction where the key portions 40 are released from the engaging grooves 42. As a result, when the button portion 60 is pressed for a long time, the receiver portion 18 fully opens.

Therefore, in the mobile phone 12, it is possible to conveniently select an appropriate opening angle of the receiver portion 18 according to the pressing time of the button portion 60 when the camera function is used or the telephone function is used.

The cap 52 is fixed to the end of the case 24, and the sub-cam 48 pressed by the twisting coil spring 46 abuts against the cap 52. Here, the plurality of the engaging depressions 54 is formed in the surface of the cap 52 abutting against the sub-cam 48, and the engaging ribs 50 are formed on the surface of the sub-cam 48 abutting against the cap 52 for engaging the engaging depressions 54.

The sub-cam 48 pressed by the twisting coil spring 46 abuts against the cap 52, so that the sub-cam 48 is urged toward the side of the cap 52.

As a result, the engaging depressions 54 of the cap 52 reliably engage the engaging ribs 50 of the sub-cam 48. The engaging ribs 50 of the sub-cam 48 reliably engage the engaging depressions 54 of the cap 52 in the state where the key portions 40 engage the engaging grooves 42 or 44. Accordingly, it is possible to restrict the rotation of the rotational axis even through the sub-cam 48.

Accordingly, when the hinge structure is applied to the axial portion of the mobile phone 12, the receiver portion 18 does not wobble in the state where the key portions 40 engage the engaging grooves 42 or 44.

As shown in FIG. 9(B), the sidewalls of the engaging depressions 54 of the cap 52 abutting against the engaging ribs 50 of the sub-cam 48 are composed of the substantially standing walls and inclined surfaces. The sidewalls 54A of the engaging depressions 54 corresponding to the sidewalls 50A of the engaging ribs 50 abutting in the opening direction (arrow direction) of the receiver portion 18 are the substantially standing walls formed substantially in parallel to the sidewalls 50A of the engaging ribs 50 of the sub-cam 48.

Accordingly, in the state where the key portions 40 engage the engaging grooves 42 or 44, the twisting force of the twisting coil spring 46 is locked by the engagement between the engaging ribs 50 of the sub-cam 48 and the engaging depressions 54 of the cap 52, and the frictional force by the twisting force is not generated between the engaging ribs 50 and the engaging depressions 54.

As a result, with the restoring force of the compression force of the coil spring 56, the actuator 36 is pulled with the maximum force. Therefore, it is possible to reliably hold the receiver portion 18 at the full-opened position (open angle 165°) or the open angle approximately 90°.

As shown in FIGS. 9(A) and 9(B), the sidewalls 42B and 44B of the engaging grooves 42 or 44 abutting the corners of the sidewalls 40B of the key portions 40, and the sidewalls 54B abutting the corners of the sidewalls 50B of the engaging ribs 50 of the sub-cam 48 have the inclined surfaces. Accordingly, in order to apply a rotational force to the actuator 36, it is necessary to apply a force to the key portions 40 and the engaging ribs 50 of the sub-cam 48 to move over the inclined surfaces in addition to the twisting force of the twisting coil spring 46. As a result, it is possible to increase the force for holding the receiver portion 18, and even when the mobile phone 12 is shaken, the receiver portion 18 does not wobble.

Furthermore, the cam grooves 34 are provided for converting the sliding force of the actuator 36 into the rotational force of the cam member 26. Accordingly, when the actuator 36 slides for the predetermined distance, the cam member 26 can reliably rotate by the predetermined angle.

Also, the button portion 60 and the end of the actuator 36 are fixed with the joint 58. The coil spring 56 is provided between the joint 58 and the cap 52, and the coil spring 56 urges the button portion 60 in the direction where the button portion 60 separates from the cap 52, so that the actuator 36 is pulled back through the joint 58 in a natural state.

The force for pulling back the actuator 36 is proportional to the force of the engagement between the key portions 40 and the engaging grooves 42. Accordingly, in order to increase the force of the engagement between the key portions 40 and the engaging grooves 42, it is preferable to increase the force for pulling back the actuator 36. However, in this case, a resistance force against pressing the button portion 60 increases, so that the operation is deteriorated.

On the other hand, the twisting force is applied in the twisting coil spring 46, and the frictional force is generated between the key portions 40 and the engaging grooves 42 with the twisting force. The frictional force turns to the resistance force when the rotational axis is pulled back.

Therefore, the coil spring 56 is provided for pulling back the actuator 36 in addition to the twisting coil spring 46, so that the force for pulling back the actuator 36 can be decreased and the resistance force when the button portion 60 is pressed is reduced.

On the other hand, in the damper 92, the distance between the inner periphery surface 94A of the housing 94 and the end of each wing portion 98 is changed according to the rotational angle of the shaft 112, so that the compressive resistance generated between the end of each wing portion 98 and the inner periphery surface 94A of the housing 94 is changed.

More specifically, as the rotational angle of the shaft 112 increases, the distance between the inner periphery surface 94A of the housing 94 and the end of each wing portion 98 becomes narrower. Also, the dividing walls 108 project from the inner periphery surface 94A of the housing 94 for forming the liquid chambers 110A and 110B communicating each other.

Accordingly, when the wing portions 98 move, the volumes of the liquid chambers 110A and 110B are reduced and the compressibility ratio of the viscous fluid can be increased, so that the viscous resistance on the wing portions 98 can be increased with the rotation of the wing portions 98.

Also, as the rotational angle of the shaft 112 increases, the distance between the inner periphery surface 94A of the housing 94 and the end of each wing portion 98 become small, so that the passing resistance when the viscous fluid passes through the gap between the inner periphery surface 94A of the housing 94 and the end of each wing portion 98 can be increased, and the viscous resistance on the wing portion 98 is further increased.

When the viscous fluid flows between the liquid chambers 110A and 110B, the viscous fluid is compressed and the passing resistance of the viscous fluid passing through the gap between the outer periphery surface of the shaft 112 and the end of each dividing wall 108 is applied, so that the high torque (high braking force) is obtained.

As described above, it is possible to change the stress applied on the wing portions 98 according to the opening angle of the receiver portion 18. Therefore, it is possible to efficiency increase the torque and to obtain the high torque (high braking force).

When the key portions 40 are released from the engaging grooves 42 or 44, the receiver portion 18 is urged in the opening direction with the twisting coil spring 46. There are large fluctuations in the torque of the receiver portion 18 according to the opening angle of the receiver portion 18. That is, at the side that the receiver portion 18 starts to open, the torque for opening the receiver portion 18 is large, and at the side of completion of the opening (fully opened), the torque becomes small.

As a result, the braking force is changed according to the opening angle of the receiver portion 18, and the braking force is made small with the damper 92 at the side that the receiver portion 18 starts to open, and the braking force is made large at the side of the completion of the opening (fully opened). Accordingly, it is possible to open the receiver portion 18 speedy up to approximately 90°. The rotational speed is reduced after 90°, so that the receiver portion 18 can open slowly.

In the embodiment, when the receiver portion 18 fully opens (165°) from 45°, the damper 92 applies the braking force to the receiver portion 18. It is acceptable to set an appropriate angle according to the torque fluctuation of the receiver portion 18, not limited to 45° and 165°.

Also, here, during the opening angle from 0° to 45°, the damper 92 does not apply the raking force, i.e. the idle running. Alternatively, the idle running may be omitted.

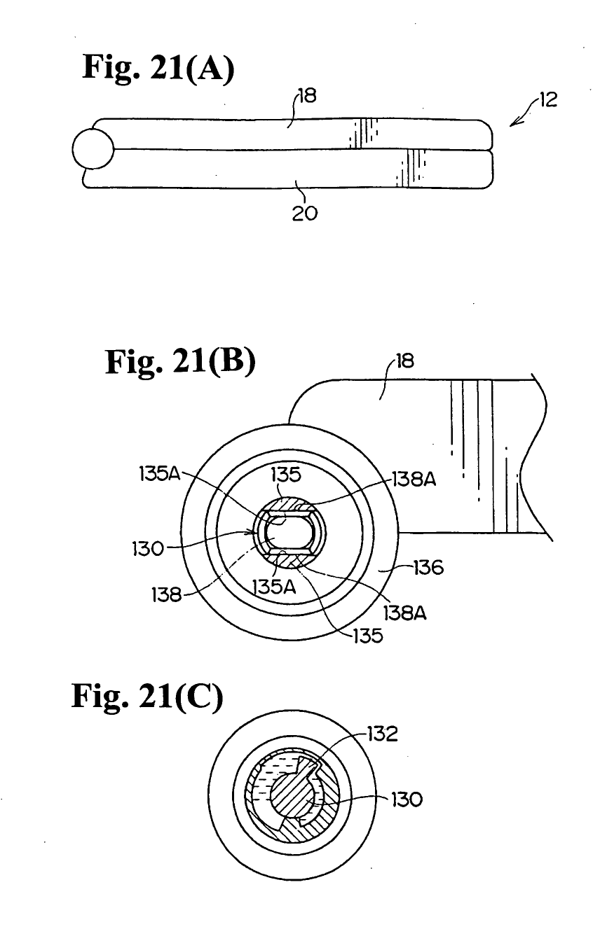

For example, as shown in FIGS. 21(A) to 21(C), a single wing portion 132 projects from the outer periphery surface of a shaft 130, and rotates inside a housing 134. By making the wing portion single, it is possible to rotate the shaft 130 up to 165°, i.e. the opening angle of the receiver portion 18. Accordingly, it is acceptable to control the torque fluctuation of the receiver portion 18 by means of a damper 135 from 0° to 165° of the receiver portion 18.

In an axial portion 136, abutting projections 135 including abutting surfaces 135A are provided, and have an area substantially same as flat surface portions 138A formed in an abutting portion 138 of the shaft 130. The abutting surfaces 135A make surface contact with the flat surface portions 138A, so that the shaft 130 rotates through the abutting projections 135 and the abutting portion 138 through the rotation of the axial portion 136.

The abutting surfaces 135A have an area substantially same as the flat surface portions 138A. Accordingly, it is possible to make a volume of the abutting projections 135 larger than that of the abutting projections 120 and 122 (refer to FIGS. 21(A)-21(C)), thereby reinforcing the abutting projections 135 and eliminating a problem such as damage.

Here, the hinge unit 10 is provided to obtain the damper effect. Alternatively, the damper effect may not be applied to the hinge unit 10, and only the damper 92 applies the braking force to the receiver portion 18.

Also, the engaging grooves 42 and 44 are formed on the inner periphery surface of the stopper 38 at the positions shifted by approximately 90° for engaging the key portions 40, so that the receiver portion 18 can be held at the opening angle of approximately 90°, but it is not limited to this. For example, the receiver portion 18 may be held at the opening angle of 100°, or at multiple positions between the position that the receiver portion 18 starts to open and the position that the receiver portion 18 fully opens.

Further, the engaging ribs 50 are formed in the sub-cam 48 and the engaging depressions 54 are formed in the cap 52. As long as the sub-cam 48 and the cap 52 are locked not to rotate through the engagement, it is not limited to this. For example, the depressions may be formed in the sub-cam, and the projections may be formed in the cap for engaging the depressions.

All the components of the hinge unit 10 are stored together in the case. Alternatively, the components may be directly mounted to the axis portion of the housing member as a case. In considering a step of mounting, it is desirable to mount together in the case 24 as in the embodiment.

Further, the invention may be applied to a device in which a pair of housing members rotates relative to each other, not limited to the mobile phone. For example, the invention can be applied to a device in which a cover opens at a specific angle such as Audio/Visual equipment.

In the present invention, the structure is made as described above. Accordingly, in the first embodiment of the invention, it is possible to selectively engage or disengage the key portions with or from the engaging portions by changing the pressing time of the button portion. Therefore, when the hinge structure is applied to the mobile phone with the camera, it is possible to conveniently select an appropriate open angle of the receiver portion according to the pressing time of the button portion when the mobile phone is used as the camera or as the phone. Further, in addition to the first urging means, the second urging means is provided for pulling the rotational axis, thereby reducing the force required for pulling the rotational axis and the resisting force against the pressing force of the button portion.

In the second embodiment of the present invention, the depressions or the projections of the cap can steadily engage the projections or the depressions of the sub-cam. In a state that the key portion engages the engaging portions, the depressions or the projections of the cap securely engage the projections or the depressions of the sub-cam, so that the rotation of the rotational axis even through the sub-cam can be restricted.

In the third and fourth embodiments of the present invention, the twisting force of the first urging means is locked. When the rotational axis slides, no frictional force by the twisting force is applied between the rotational axis and the sub-cam. As a result, it is possible to use the urging force of the second urging means (force of pulling back the rotational axis) to the maximum extent. Therefore, the receiver portion can be reliably held at the fully opened position or at approximately 90° of the receiver portion. Further, the corners of the projections of the sub-cam abut against the inclined surfaces of the depressions of the cap. Accordingly, in order to rotate the rotational axis, it is necessary to apply a force so that the projections of the sub-cam climb over the inclined surfaces, in addition to the resisting force by the twisting force of the first urging means. As a result, it is possible to strongly hold the receiver portion, thereby preventing rattle of the receiver portion when the mobile phone is shaken.

In the fifth embodiment of the present invention, the cam groove is formed for converting the sliding force of the rotational axis into the rotational force of the drive cap. Accordingly, when the rotational axis slides for a predetermined distance, the drive cap can reliably rotate by a predetermined angle.

In the sixth embodiment of the present invention, when the hinge unit is applied to the mobile phone with a camera function, the receiver portion is hold at an angle between 80° and 140° and approximately 165°. When the mobile phone includes a timer function with a self-timer, it is possible to conveniently hold the receiver portion at approximately 90°.

In the seventh embodiment of the present invention, the case of the hinge unit is fixed to the axial portion of the first housing member, and the rotational axis of the hinge unit is fixed to the axial portion of the second housing member, so that the first housing member can rotate relative to the second housing member.

In the eighth embodiment of the present invention, the urging force is changed according to the opening angle of the first housing member or the second housing member. At the side that the first housing member or the second housing member starts to open, the breaking force is small. At the side of the completion of the opening (fully opened), the breaking force becomes large. As a result, the first housing member or the second housing member can open speedy up to a predetermined angle. After the predetermined angle, the opening speed is reduced, and the first housing member or the second housing member opens slowly.

In the ninth embodiment of the present invention, when the wing portion moves, the volume of the liquid chamber is reduced to increase the compression ratio of the viscous fluid, thereby increasing viscous resistance on the wing portion with the rotation of the wing portion. Further, the distance between the inner periphery surface of the housing and the end of the wing portion is reduced while the rotational angle of the rotor increases. Accordingly, it is possible to further increase the viscous resistance of the fluid passing through the gap between the inner periphery surface of the housing and the end of each wing portion. The viscous resistance on the wing portion can be additionally increased. When the viscous fluid flows between the liquid chambers, the viscous fluid is also compressed and the passing resistance of the fluid passing through the gap between the outer periphery surface of the rotor and the end of each dividing wall is generated, thereby obtaining the high torque (high braking force).

What is claimed is:

1. A hinge unit comprising:
a case,
a rotational axis rotatably housed in the case and disposed slidably in an axial direction of the case, said rotational axis having two ends and a key portion formed on an outer periphery surface thereof,
a stopper fixed to the case for receiving the rotational axis to pass therethrough, and having an engaging portion for engaging the key portion,
a sub-cam slidably inserted into one of the two ends of the rotational axis and rotating together with the rotational axis,
first urging means connected to the sub-cam and the stopper for applying a twisting force to the sub-cam and urging the sub-cam in a direction away from the stopper,
a cap fixed to the case for receiving the rotational axis to pass therethrough and for restricting a sliding movement of the sub-cam,
fastener means fixed the other of the two ends of the rotational axis and arranged to be slidable relative to the case, and
second urging means provided between the cap and the fastener means, said second urging means urging the fastener means in a direction away from the cap and pulling the rotational axis through the fastener means to engage the engaging portion with the key portion so that upon pressing the rotational axis in a direction against the second urging means, the engaging portion is released form the key portion.

2. A hinge unit according to claim 1, further comprising a button portion fixed to the fastener means for pressing the rotational axis in the direction against the second urging means.

3. A hinge unit according to claim 1, wherein said cap further includes a plurality of first depressions or first projections formed on a surface facing the sub-cam, and said sub-cam further includes a plurality of second depressions or second projections formed on a surface facing the cap for engaging with or disengaging from the first depressions or the first projection through rotation.

4. A hinge unit according to claim 3, wherein each of said first depressions of the cap includes an inclined wall and a substantially standing wall, said second projection of the sub-cam being pressed against the substantially standing wall with the twisting force of the first urging means, said second projection of the sub-cam abutting against the inclined wall at a corner thereof.

5. A hinge unit according to claim 3, wherein each of said second depressions of the sub-cam includes an inclined wall and a substantially standing wall, said first projection of the cap being pressed against the substantially standing wall with the twisting force of the first urging means, said first projection of the cap abutting against the inclined wall at a corner thereof.

6. A hinge unit according to claim 1, further comprising a drive cap fitted to the one end of the rotational axis and having a cam groove formed on an inner periphery surface thereof, said rotational axis having a cam portion formed on an outer periphery surface thereof for engaging the cam groove of the drive cap so that the drive cap rotates when the rotational axis slides in the axial direction of the case.

7. A hinge unit according to claim 1, wherein said engaging portion is disposed at a position corresponding to a position of the key portion when the rotational axis rotates by an angle between 80° and 140° or approximately 165°.

8. A hinge unit according to claim 3, wherein said first depression is disposed at a position corresponding to a position of the second projection when the rotational axis rotates by an angle between 80° and 140° or approximately 165°.

9. A hinge unit according to claim 3, wherein said first projection is disposed at a position corresponding to a position of the second depression when the rotational axis rotates by an angle between 80° and 140° or approximately 165°.

10. A hinge structure comprising said hinge unit according to claim 1, a first housing member having an axial portion attached to said case, a second housing having an axial portion attached to one of said rotational axis and said drive cap so that the first housing member rotates relative to the second housing member.

11. A hinge structure according to claim 10, further comprising damper means provided in one of the axial portions of the first housing member and the second housing member for applying a braking force to the first urging means according to an opening angle of the first housing member relative to the second housing member after the key portion is released from the engaging portion.

12. A hinge structure according to claim 10, wherein said damper means includes a housing having a substantially cylindrical shape and filled with viscous fluid, a rotor rotatably disposed in the housing and having wing portions, and dividing walls projecting from an inner periphery surface of the housing for forming a plurality of liquid chambers communicating with each other, said housing and wing portions being formed such that a distance between an end of the wing portion and the inner periphery surface of the housing changes according to a rotational angle of the rotor.
